(19) United States
(12) Patent Application Publication
(10) Pub. No.: US 2016/0103958 A1
(43) Pub. Date: Apr. 14, 2016

(54) SYSTEMS, METHODS, AND COMPUTER PROGRAM PRODUCTS FOR MERGING A NEW NUCLEOTIDE OR AMINO ACID SEQUENCE INTO OPERATIONAL TAXONOMIC UNITS

(71) Applicant: UNIVERSITY OF GUELPH, Guelph (CA)

(72) Inventors: Paul Hebert, Guelph (CA); Sujeevan Ratnasingham, Guelph (CA)

(73) Assignee: University of Guelph, Guelph (CA)

(21) Appl. No.: 14/897,321

(22) PCT Filed: Jun. 13, 2014
(86) PCT No.: PCT/CA2014/050554

§ 371 Date: Dec. 10, 2015

Related U.S. Application Data
(60) Provisional application No. 61/835,116, filed on Jun. 14, 2013.

(51) Int. Cl. G06F 19/24; G06F 17/30; G06F 19/14

(52) U.S. Cl. CPC G06F 19/24; G06F 19/14; G06F 17/30598

(57) ABSTRACT

The present disclosure provides a method for filtering sequence clusters during a process of merging a newly generated nucleotide or amino acid sequence with a set of previously clustered sequences. In another aspect, the disclosure provides a method for assigning newly generated nucleotide or amino acid sequences to presumptive species called operational taxonomic units. In yet another embodiment, the sequences are derived from the cytochrome c oxidase I gene.

### FIELD

The present invention relates to a process of merging a new nucleotide or amino acid sequence into operational taxonomic units (OTUs) based on sequence similarity.

### SUMMARY

In accordance with an aspect of the invention, there is provided a method for filtering out clusters from a group of clusters from further consideration during a process of merging a new nucleotide or amino acid sequence into the group of clusters based on sequence similarity, the method comprising: a) determining a candidate cluster set including a plurality of candidate clusters, each candidate cluster having a maximum intra-cluster distance that is less than a pre-defined maximum intra-cluster distance threshold, wherein each candidate cluster comprises a plurality of previously classified nucleotide or amino acid sequences; and the maximum intra-cluster distance of each candidate cluster is a measure of the distance between the two previously classified nucleotide or amino acid sequences that are the furthest from each other in the plurality of previously classified nucleotide or amino acid sequences of the candidate cluster; b) using the processor of the computer system to determine a plurality of sets of representative sequences, by determining, for each of the candidate clusters in the candidate cluster set, a set of one or more representative sequences, wherein for at least one candidate cluster, the number of representative sequences in the set of one or more representative sequences of the candidate cluster is less than the number of previously classified nucleotide or amino acid sequences in the plurality of previously classified nucleotide or amino acid sequences of the candidate cluster; c) using the processor to determine a plurality of candidate cluster distance measures, by determining, for each of the candidate clusters in the candidate cluster set, a candidate cluster distance measure between the new nucleotide or amino acid sequence and the candidate cluster, wherein the candidate cluster distance measure between the new nucleotide or amino acid sequence and the candidate cluster is determined by determining the distance between the nucleotide or amino acid sequence and the set of one or more representative sequences of the candidate cluster; and d) using the processor to filter out from further consideration each candidate cluster in the candidate cluster set if and only if the associated candidate cluster distance measure of the candidate cluster is greater than a pre-defined filtering threshold, and retaining all other candidate clusters in the candidate cluster set for further consideration.

In accordance with another aspect of the invention, there is provided a method for operating a computer system for filtering sequence clusters from a set of sequence clusters during a process of merging a new sequence with the set of sequence clusters based on sequence similarity, wherein the new sequences are nucleotide or amino acid sequences, the method comprising: a) selecting one or more representative sequences from each sequence cluster in the non-empty set of sequence clusters with a maximum intra-cluster distance less than a pre-defined maximum intra-cluster distance threshold, wherein each sequence cluster comprises a plurality of nucleotide or amino acid sequences, for each sequence cluster, a number of representative sequences is less than the total number of nucleotide or amino acids sequences in the sequence cluster; and the maximum intra-cluster distance of a cluster is the largest pair-wise distance between any two sequences in the cluster; b) for each sequence cluster in the non-empty set of sequence clusters with a maximum intra-cluster distance less than a pre-defined maximum intra-cluster distance threshold operating the processor to compute a distance between the representative sequence or sequences and the new sequence to be merged with the set of sequence clusters; c) using a processor of a computer system to filter out from further consideration sequence clusters wherein the distance of their representative sequence to the new sequence exceeds twice the maximum intra-cluster distance threshold, and retaining all other sequence clusters in the set of sequence clusters for further consideration.

In accordance with an aspect of an embodiment of the present invention there is provided a method for operating a computer system to filter out clusters from a group of clusters from further consideration during a process of merging a new nucleic acid or amino acid sequence into the group of clusters based on sequence similarity, the computer comprising a processor and a memory. The method comprises a) determining a candidate cluster set including a plurality of candidate clusters, each candidate cluster comprising a plurality of previously classified nucleic acid or amino acid sequences wherein each previously classified nucleic acid or amino acid sequence in a cluster is closer to at least one other previously classified nucleic acid or amino acid sequence in that cluster than to any previously classified nucleic acid or amino acid sequences in other clusters; b) using the processor of the computer system to determine a plurality of sets of representative sequences, by determining, for each of the candidate clusters in the candidate cluster set, a set of one or more representative sequences, wherein for at least one candidate cluster, the number of representative sequences in the set of one or more representative sequences of the candidate cluster is less than the number of previously classified nucleic acid or amino acid sequences in the plurality of previously classified nucleic acid or amino acid sequences of the candidate cluster; c) using the processor to determine a plurality of candidate cluster distance measures, by determining, for each of the candidate clusters in the candidate cluster set, a candidate cluster distance measure between the new nucleic acid or amino acid sequence and the candidate cluster, wherein the candidate cluster distance measure between the new nucleic acid or amino acid sequence and the candidate cluster is determined by determining the distance between the nucleic acid or amino acid sequence and the set of one or more representative sequences of the candidate cluster; and d) using the processor to filter out from further consideration each candidate cluster in the candidate cluster set if and only if the associated candidate cluster distance measure of the candidate cluster is greater than a pre-defined filtering threshold, and retaining and storing in the memory all other candidate clusters in the candidate cluster set for further consideration.

In accordance with another aspect of this embodiment of the present invention there is provided a data processing system for filtering out clusters from a group of clusters from further consideration during a process of merging a new nucleic acid or amino acid sequence into the group of clusters based on sequence similarity, the data processing system comprising a processor, a memory, and instructions recorded in the memory for configuring the processor to a) determine a candidate cluster set including a plurality of candidate clusters, each candidate cluster comprising a plurality of previously classified nucleic acid or amino acid sequences wherein each previously classified nucleic acid or amino acid sequence in a cluster is closer to at least one other previously classified nucleic acid or amino acid sequence in that cluster than to any previously classified nucleic acid or amino acid sequences in other clusters; b) determine a plurality of sets of representative sequences, by determining, for each of the candidate clusters in the candidate cluster set, a set of one or more representative sequences, wherein for at least one candidate cluster, the number of representative sequences in the set of one or more representative sequences of the candidate cluster is less than the number of previously classified nucleic acid or amino acid sequences in the plurality of previously classified nucleic acid or amino acid sequences of the candidate cluster; c) determine a plurality of candidate cluster distance measures, by determining, for each of the candidate clusters in the candidate cluster set, a candidate cluster distance measure between the new nucleic acid or amino acid sequence and the candidate cluster, wherein the candidate cluster distance measure between the new nucleic acid or amino acid sequence and the candidate cluster is determined by determining the distance between the nucleic acid or amino acid sequence and the set of one or more representative sequences of the candidate cluster; and d) filter out from further consideration each candidate cluster in the candidate cluster set if and only if the associated candidate cluster distance measure of the candidate cluster is greater than a pre-defined filtering threshold, and retaining and storing in the memory all other candidate clusters in the candidate cluster set for further consideration.

In accordance with yet another aspect of this embodiment of the present invention there is provided a computer program product for use on a computer system to filter out clusters from a group of clusters from further consideration during a process of merging a new nucleic acid or amino acid sequence into the group of clusters based on sequence similarity, the computer program product comprising a non-transitory computer readable recording medium, and instructions recorded on the recording medium for instructing the computer system to a) determine a candidate cluster set including a plurality of candidate clusters, each candidate cluster comprising a plurality of previously classified nucleic acid or amino acid sequences wherein each previously classified nucleic acid or amino acid sequence in a cluster is closer to at least one other previously classified nucleic acid or amino acid sequence in that cluster than to any previously classified nucleic acid or amino acid sequences in other clusters; b) determine a plurality of sets of representative sequences, by determining, for each of the candidate clusters in the candidate cluster set, a set of one or more representative sequences, wherein for at least one candidate cluster, the number of representative sequences in the set of one or more representative sequences of the candidate cluster is less than the number of previously classified nucleic acid or amino acid sequences in the plurality of previously classified nucleic acid or amino acid sequences of the candidate cluster; c) determine a plurality of candidate cluster distance measures, by determining, for each of the candidate clusters in the candidate cluster set, a candidate cluster distance measure between the new nucleic acid or amino acid sequence and the candidate cluster, wherein the candidate cluster distance measure between the new nucleic acid or amino acid sequence and the candidate cluster is determined by determining the distance between the nucleic acid or amino acid sequence and the set of one or more representative sequences of the candidate cluster; and d) filter out from further consideration each candidate cluster in the candidate cluster set if and only if the associated candidate cluster distance measure of the candidate cluster is greater than a pre-defined filtering threshold, and retaining and storing in the memory all other candidate clusters in the candidate cluster set for further consideration.

In accordance with an aspect of another embodiment of the present invention there is provided a method for operating a computer system to derive data from a plurality of nucleic acid sequences, the computer comprising a processor and a memory, the method comprising providing a plurality of computer-readable sequence representations comprising, for each nucleic acid sequence in the plurality of nucleic acid sequences, a corresponding computer-readable sequence representation having an ordered sequence of residue representations comprising, for each residue in that nucleic acid sequence, a corresponding residue representation, wherein each nucleic acid sequence in the plurality of nucleic acid sequences comprises at least X residues, X being an integer greater than 300; providing a scanning window for collecting sequence-specific data for each sequence representation in the plurality of computer-readable sequence representations by sliding along each sequence in the plurality of computer-readable sequence representations, the scanning window having a pre-defined length W defining a number of residue representations in a portion of the sequence representation that are concurrently scannable by the computer by positioning the scanning window over that portion of the sequence representation, W being an integer greater than 10 and less than X; operating the processor to position the scanning window at a first portion of the sequence representation, scan the first portion of the sequence representation to obtain first portion scan results; and then operating the processor to reposition the scanning window at a second portion of the sequence representation, scan the second portion of the sequence representation to obtain second portion scan results, the second portion being different from the first portion.

In accordance with another aspect of this embodiment of the present invention there is provided a data processing system for deriving data from a plurality of nucleic acid sequences, the data processing system comprising a processor, a memory, and instructions recorded in the memory for configuring the processor to provide a plurality of computer-readable sequence representations comprising, for each nucleic acid sequence in the plurality of nucleic acid sequences, a corresponding computer-readable sequence representation having an ordered sequence of residue representations comprising, for each residue in that nucleic acid sequence, a corresponding residue representation, wherein each nucleic acid sequence in the plurality of nucleic acid sequences comprises at least X residues, X being an integer greater than 300; provide a scanning window for collecting sequence-specific data for each sequence representation in the plurality of computer-readable sequence representations by sliding along each sequence in the plurality of computer-readable sequence representations, the scanning window having a pre-defined length W defining a number of residue representations in a portion of the sequence representation that are concurrently scannable by the computer by positioning the scanning window over that portion of the sequence.

In accordance with yet another aspect of this embodiment of the present invention there is provided a computer program product for use on a computer system to derive data from a plurality of nucleic acid sequences, the computer program product comprising a non-transitory computer readable recording medium, and instructions recorded on the recording medium for instructing the computer system to provide a plurality of computer-readable sequence representations comprising, for each nucleic acid sequence in the plurality of nucleic acid sequences, a corresponding computer-readable sequence representation having an ordered sequence of residue representations comprising, for each residue in that nucleic acid sequence, a corresponding residue representation, wherein each nucleic acid sequence in the plurality of nucleic acid sequences comprises at least X residues, X being an integer greater than 300; and provide a scanning window for collecting sequence-specific data for each sequence representation in the plurality of computer-readable sequence representations by sliding along each sequence in the plurality of computer-readable sequence representations, the scanning window having a pre-defined length W defining a number of residue representations in a portion of the sequence representation that are concurrently scannable by the computer by positioning the scanning window over that portion of the sequence.

### DRAWINGS

Several embodiments of the present invention will now be described in detail with reference to the drawings, in which:

FIG. 1 shows possible patterns of association between species and BINs. Although just two species are considered, they enable illustration of the four possible patterns of association.

FIG. 2 shows correspondence between the species present in eight datasets and OTUs recognized through single linkage clustering with sequence divergence thresholds ranging from 0.1-6.0%. Green indicates the number of OTUs whose members perfectly match species; yellow shows those that merge members of two or more species; orange indicates cases where a species was split into two or more OTUs and red represents a mixture of splits and merges.

FIG. 3 shows the BIN pipeline for OTU generation employing RESL. OTUs initially generated through single linkage clustering are subsequently refined through Markov clustering.

FIG. 4 shows the correspondence between the number of OTUs generated by RESL and the number of species in eight datasets.

FIG. 5 shows a comparison of BIN and species boundaries in eight datasets. Each inner ring partitions species, based on their assignment to BINs as MATCHES (green), MERGES (yellow), SPLITS (orange) or MIXTURES (red). Each outer ring categorizes BINs into those that MATCHED species, MERGED species, SPLIT species or MIXTURES using the same colour scheme. The number below each chart is the OTU count while the percentage indicates the incidence of OTUs that were not MATCHES.

FIG. 6 shows a comparison of the performance of four algorithms in OTU assignments for the Lepidoptera of eastern North America dataset. Each inner ring partitions species, based on their assignment to BINs as MATCHES (green), MERGES (yellow), SPLITS (orange) or MIXTURES (red). Each outer ring categorizes BINs into those that MATCHED species, SPLIT species, MERGED species or MIXTURES using the same colour scheme. The number below each chart is the OTU count while the percentage indicates the incidence of OTUs that were not MATCHES.

FIG. 7 shows a comparison of the performance of the ABGD, CROP, jMOTU, and RESL algorithms in OTU assignments for eight datasets. Each bar consists of four categories: green—percent of MATCHES, yellow—percent of MERGES, orange—percent of SPLITS, red—percent of MIXTURES.

FIG. 8 shows the computational time required by the ABGD, CROP, jMOTU, and RESL algorithms to generate OTUs for eight datasets.

FIG. 9 shows a comparison of the performance of the GMYC and RESL algorithms in OTU assignments for eight datasets. Side by side comparisons for MATCHES, LUMPS, SPLITS, and MIXTURES.

FIG. 10 shows computational time required by the GMYC and RESL algorithms to generate OTUs for eight datasets.

FIG. 11 shows the BIN page for Danaus plexippus (Linnaeus, 1758), the monarch butterfly.

FIG. 12 is a schematic representation of one possible embodiment of the disclosed method in which previously generated sequence clusters are filtered during a process of merging a new sequence with the set of previously generated sequence clusters.

FIG. 13 is a schematic representation of one possible embodiment of the disclosed method in which previously generated clusters are filtered during a process of merging a new sequence with the group of existing clusters.

FIG. 14 is a block diagram illustrating the computing device that performs the steps necessary to assign a new nucleotide or amino acid sequence to an OTU, in accordance with an example embodiment.

The drawings, described above, are provided for purposes of illustration, and not of limitation, of the aspects and features of various examples of embodiments described herein. The drawings are not intended to limit the scope of the teachings in any way. For simplicity and clarity of illustration, elements shown in the figures have not necessarily been drawn to scale. The dimensions of some of the elements may be exaggerated relative to other elements for clarity. It will be appreciated that for simplicity and clarity of illustration, where considered appropriate, reference numerals may be repeated among the figures to indicate corresponding or analogous elements or steps.

### DESCRIPTION OF VARIOUS EMBODIMENTS

The embodiments of the systems, processes and methods described herein may be implemented in hardware or software, or a combination of both. Alternatively, these embodiments may also be implemented in computer programs executed on programmable computers each comprising at least one processor (e.g., a microprocessor), a data storage system (including volatile and non-volatile memory and/or storage elements), at least one input device, and at least one output device. For example and without limitation, the programmable computers (referred to below as computing devices) may be a personal computer, laptop, personal data assistant, cellular telephone, smart-phone device, tablet computer, and/or wireless device. For any software components, program code is applied to input data to perform the functions described herein and generate output information. The output information is applied to one or more output devices, in known fashion.

Each software component or program may be implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM) readable by a general or special purpose programmable computer, for configuring and operating the computer when the storage media or device is read by the computer to perform the procedures described herein. The subject system may also be considered to be implemented as a computer-readable storage medium, configured with a computer program, where the storage medium so configured causes a computer to operate in a specific and predefined manner to perform the functions described herein.

Furthermore, the processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, this description and the drawings are not to be considered as limiting the scope of the embodiments described herein in any way, but rather as merely describing the implementation of the various embodiments described herein.

### 1. OUTLINE OF CONTENT

Because many animal species are undescribed, and because the identification of known species may often be difficult, interim taxonomic nomenclature has often been used in biodiversity analysis. By assigning individuals to presumptive species, called operational taxonomic units (OTUs), these systems speed investigations into the patterning of biodiversity and may enable studies that would otherwise be impossible. Although OTUs have conventionally been separated through their morphological divergence, DNA-based delineations are not only feasible, but may have important advantages. OTU designation may be automated, data may be readily archived, and results may be easily compared among investigations. This study uses these attributes to develop a persistent, species-level taxonomic registry for the animal kingdom based on the analysis of patterns of nucleotide variation in the barcode region of the cytochrome c oxidase I (COI) gene. It begins by examining the correspondence between groups of specimens identified to a species through prior taxonomic work and those inferred from the analysis of COI sequence variation using one new (RESL) and four established (ABGD, CROP, GMYC, jMOTU) algorithms. It subsequently describes the implementation, and structural attributes of the Barcode Index Number (BIN) system. Aside from a pragmatic role in biodiversity assessments, BINs may aid revisionary taxonomy by flagging possible cases of synonymy, and by collating geographical information, descriptive metadata, and images for specimens that may belong to the same species, even if it is undescribed. More than 274,000 BIN web pages are now available, creating a biodiversity resource that is positioned for rapid growth.

Most animal species await description [1] and many named taxa actually represent a species complex [2]. It has been estimated that the cost of describing all animal species will exceed US $270 billion and require centuries [3, 4]. Given this situation, it is clear that new approaches may be needed to support biodiversity assessments in advance of fully developed species-level taxonomy. Biodiversity researchers have often attempted to address the taxonomic impediment in a local or regional context by assigning specimens to operational taxonomic units (OTUs) using morphological differences perceived to be indicators of species boundaries. However, it can be very difficult to codify morphology-based OTUs in a format which allows their comparison among studies. The adoption of DNA sequences as a basis for OTU classification may escape this constraint; their digital nature may aid the application of standardized protocols for OTU designation, the comparison of results among studies, and data preservation.

### 1.1 Molecular Approaches to OTU Designation

Automated DNA-based approaches for OTU designation first saw application in ‘taxonomy-free’ groups such as bacteria [5, 6] and fungi [7, 8], but they have also proven useful for probing biodiversity patterns in animal lineages where morphology-based taxonomy can be difficult [9, 10]. Although molecular analyses enable initial biodiversity evaluation in such taxa, there may be no objective way to select the algorithm or input parameters that best recover actual species boundaries [11]. Instead, the microbial genomics community operates by convention; bacterial lineages with more than 3% sequence divergence at 16S rDNA are recognized as distinct OTUs [5], while the fungal community employs a 2% divergence criterion for the intergenic spacer region [8].

Because past studies of molecular biodiversity have focused on groups with incomplete taxonomy, the concordance between species diversity estimates gauged from morphology and molecules has rarely been quantitatively tested on a large scale (e.g. above the family level). Additionally, there may have not been an effort to standardize protocols for the delineation of animal OTUs or to develop the registration system needed to support the comparison of results among studies. These matters can be critical for any large-scale implementation of an interim taxonomic system based on DNA sequence data, but there may be another requirement. For the system to support broad application, it may have to be based upon sequence diversity in a standard gene region(s). DNA barcoding studies on animals may provide an ideal source of data because more than two million records are currently available for this 648 bp region of the cytochrome c oxidase I (COI) gene. Prior analysis of these data have established two important patterns: 1) More than 95% of animal species examined possess a diagnostic COI sequence array, and 2) COI divergences rarely exceed 2% within a named species, while members of different species typically show higher divergence [12, 13]. Although exceptions do occur, the presence of this ‘barcode gap’ [14] has been observed in many animal taxa [15-18]. Because prior studies have shown that these patterns of sequence divergence are remarkably congruent across phyla, groups with robust taxonomy can provide test sets to identify the algorithmic approach that best recognizes sequence clusters corresponding to species. The resultant algorithm can subsequently be used to analyze sequence data from groups which have seen little taxonomic investigation, illuminating species diversity in these dark taxa [19].

### 1.2 Algorithms for OTU Recognition

Algorithms based on single linkage clustering [20-23] have been widely used to quantify microbial diversity. Blaxter et al. [24] were the first to apply this method to DNA barcode data for OTU recognition in animals, examining the impact of partitioning sequences at differing levels of sequence divergence. This approach discriminated 150 OTUs among 295 tardigrade specimens when the threshold for recognition was set at two or more nucleotide substitutions, and 121 OTUs when the criterion was raised to four or more differences. Because these tardigrades lacked species identifications, it was impossible to select the threshold that led to the strongest correspondence between OTU boundaries and actual species. Jones et al. [25] extended this approach by developing an analytical package (jMOTU) that generates OTUs using single linkage clustering with a sequence divergence threshold selected by the user. Although single linkage clustering performs well, and may be computationally inexpensive, it may also lack sensitivity due to chaining [26], a factor which has motivated a search for alternate approaches to OTU recognition.

Puillandre et al. [27] developed a statistical method, Automatic Barcode Gap Discovery (ABGD), to generate OTUs based on features in sequence distance distributions that indicate the presence of a ‘barcode gap’. Their method calculates distances among all pairs of sequences in a dataset and clusters them by creating a division at points where the change in slope of the distribution is highest. Partitions are recursively evaluated for division points, and splitting is sustained until all partitions possess a unimodal distribution. ABGD produces multiple possible partitioning schemes, but it is difficult to select the outcome which best recovers true species diversity without prior knowledge of the species count or without posterior examination of the alternative hypotheses with independent data. However, selection of the scheme that generated the median number of clusters has produced good correspondence in studies of real data [27].

Hao et al. [28) proposed another analytical option. Their method, Clustering 16S rRNA for OTU Prediction (CROP), employs unsupervised Bayesian clustering. Despite its name, it can be applied to sequence data from any gene through the application of a Markov Chain Monte Carlo (MCMC) search to identify partitions by optimizing a posterior probability function. Multiple parameters are available to control cluster granularity and the extent of the search for optimality. CROP uses an optimized Needleman-Wunsch [29] algorithm to perform pairwise alignments and the Quickdist [30] algorithm to generate distances. Its workflow is heavily optimized using pre-clustering and heuristics to avoid unnecessary computation.

Pons et al. [31] proposed a model-based solution, one based in phylogenetic approaches using the General Mixed Yule Coalescent (GMYC) model that represents independently evolving entities. This strategy uses a maximum likelihood approach to detect the transition of branching patterns in the gene tree from interspecific branches, following the Yule model, to intraspecific branches, following the neutral coalescent. The model optimizes the maximum likelihood value of a threshold, such that nodes in the tree above it are classified as species diversification events, following the Yule model, while those below the threshold are determined to be following the coalescent process. As such, GMYC requires prior phylogenetic reconstruction using statistically robust methods. Although GMYC has gained popularity due to its statistical robustness and accuracy [32-34], the high computational cost of phylogeny reconstruction and GMYC computation can be a barrier to the analysis of large datasets.

### 1.3 OTU Designation Through Refined Single Linkage (RESL) Analysis

The study introduces RESL, an algorithm whose design was primarily driven by the need for rapid computation to process the current 1.8M barcode sequence records and to enable ongoing adjustments in OTU boundaries linked to the incorporation of over 10,000 new records each week. This requirement for speed and scalability may set limits on the analytical options that could be considered for adoption. After reviewing prospects, RESL was developed as a staged clustering process which may employ single linkage clustering as a tool for the preliminary assignment of records to an OTU and a subsequent finishing step that may employ Markov Clustering (MCL), a graph analytical approach. MCL employs topological information in the similarity network along with distance values to partition a graph. It can cluster records with high sequence similarity and connectivity, and may separate those with lower similarity and sparse connectivity. Connectivity may be explored through random walks of the network [35], a process that may expose regions of low traffic as potential cluster boundaries. True random walks can be computationally expensive, but MCL [36] may use simulated walks to produce similar results at a much lower cost. The MCL method analyzes weighted graph representations of similarity networks where the graph summarizes pairwise relationships among any set of objects. Sequence data are analyzed by calculating distances between every pair of records and then constructing graphs by defining each sequence as a node and creating links between pairs of sequences whose distance is below a certain threshold. The speed of MCL and its capacity to resolve cluster boundaries beyond those achievable solely through single linkage clustering may make it a useful ‘refinement step’ in OTU designation. RESL may define the boundaries of each OTU selected for analysis by generating clusters using a range of values for the inflation parameter in MCL and then selects a cluster based on a method for cluster validation such as the Silhouette index [37]. In some embodiments of the invention, only one inflation parameter may be used.

### 1.4 Species Recognition Through Sequence Analysis

An algorithmic approach based on the analysis of sequence diversity in a single gene region may be an imperfect tool for the discrimination of closely related species as they may be overlooked because of their low sequence divergence. Detailed morphological, ecological, and genetic analysis can reveal such species (e.g. [38]), but these additional sources of information may not be required to recognize the many species which possess deep sequence divergence from their nearest neighbour. For example, Homo sapiens shows 11% COI divergence from its nearest neighbour species, and most other animal species have more than 4% COI divergence from their closest relative [13, 15, 16]. Although species, such as these, with deep divergence may be readily discriminated, more algorithmic finesse may be required to optimize the discrimination of divergences involving young species from those resulting from intraspecific variation. Although no algorithm may be perfect, variation in performance is probable.

### 1.5 Benchmarking Algorithms for the Recognition of Animal Species

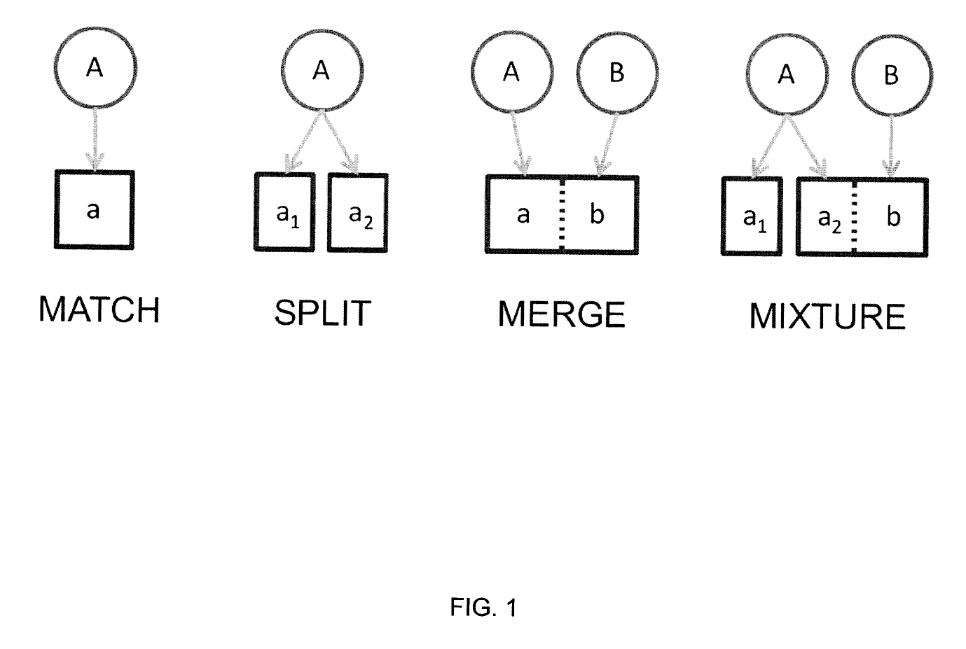

This study evaluates the performance of five algorithms (ABGD, CROP, GMYC, jMOTU, RESL) from two perspectives—their speed, and their effectiveness in recovering species boundaries. The speed of each algorithm was evaluated by determining the time it required to process eight trial datasets. The efficiency of each algorithm in recovering species boundaries was evaluated by examining the correspondence between the OTUs recovered by it and species memberships for each dataset. One statistical metric, F-Measure [39], was employed to quantify the ability of each algorithm to reproduce the reference groups (species in this case). Although mathematically concise, this metric may have the disadvantage of being abstract and may lack a fixed scale of measurement (i.e. it can only be compared within a single dataset). As a result, performance was also evaluated by direct examination of the concordance between the OTUs established by each algorithm and recognized species boundaries. This comparison was implemented by examining the correspondence between species and OTU boundaries by placing each taxon into one of four categories: MATCH, SPLIT, MERGE, or MIXTURE. A species joined the MATCH category when all of its specimens were placed in an OTU that had no other members, while it joined the SPLIT category when it was assigned to more than one OTU that had no other members. By contrast, a species placed in a single OTU together with individuals of another species was assigned to the MERGE category. Finally, each species showing a more complex partition involving both a merge and a split was scored as a MIXTURE (FIG. 1).

### 1.6 Mapping Animal Diversity: The Barcode Index Number (BIN) System

Although the selection of an effective, rapid algorithm for OTU recognition can be a key step in building a DNA-based registry for animal species, it may need to be coupled with a persistent informatics platform which maps each newly acquired sequence to an existing OTU or recognizes it as a founder. Ideally, each OTU should also be assigned a uniform resource identifier (URI) to enable the indexation of information on its members and integration with other data sources [40]. Finally, the system can be responsive to input from users, allowing community validation and annotation of the data associated with each OTU. The BIN system may not only meet these design criteria; it may also incorporate three features recognized as desirable in an interim taxonomic system—global uniqueness of names, stability of the name assigned to each specimen (or a clean audit trail), and the use of a distinctive lexicon to avoid confusion with Linnaean names [41].

This disclosure begins by examining the concordance between species inferred from prior morphological taxonomy and the OTUs recognized by RESL. Its speed and capacity to recover OTUs corresponding to known species are subsequently evaluated against four other algorithms. The final section of the disclosure describes varied aspects of the Barcode Index Number System developed within BOLD [42] to register the OTUs delineated by RESL.

### 2. MATERIALS AND METHODS

### 2.1 RESL Methodology

RESL employs a staged process to assign DNA barcode sequences to OTUs. The first step involves sequence alignment; the second generates initial OTU boundaries based on single linkage clustering, and the third evaluates opportunities for refinement of OTU boundaries using an alternative clustering method, for example, Markov clustering. In some embodiments, the second step is preceded by the construction of a binary tree index based on sequence composition. Optionally, sequence composition is measured as % GC content of a nucleic acid sequence. In some embodiments, the third step is preceded by haplotype compression, which comprises the compression of OTUs down to single representatives for each haplotype based on 0% divergence and 500 bp of overlap. The final step selects the optimal partitions for OTUs based on a cluster validation measure such as the Silhouette index. This cluster validation method can measure how tightly clusters are integrated [37]. Uncorrected pairwise distance (p-distance) may be employed for all distance calculations to avoid assumptions about the model of sequence evolution, and to maximize speed.

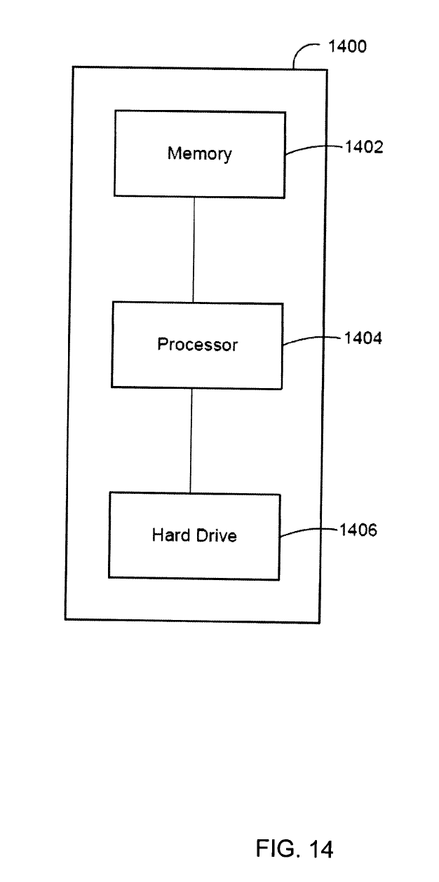

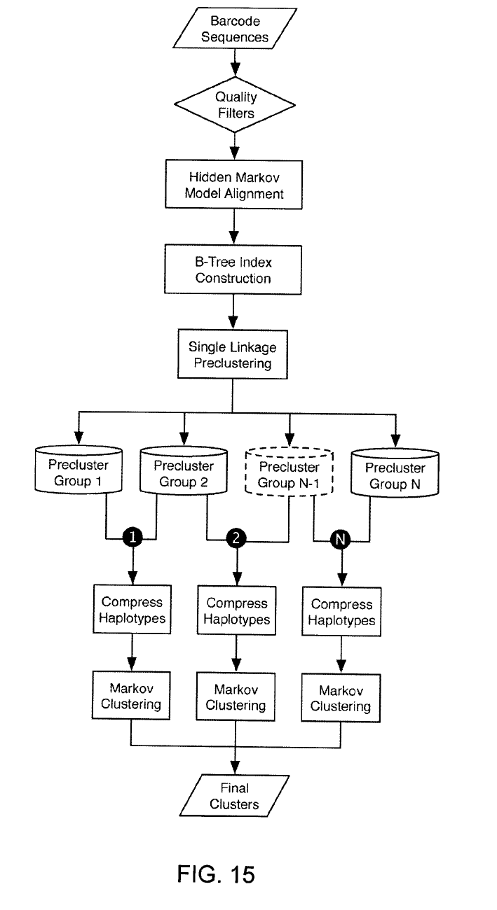

The steps described may be performed by a computing device 1400 illustrated in FIG. 14. In accordance with an example embodiment, previously constructed sequence clusters and new sequences to be merged with the sequence cluster can be stored on the hard drive (1406). The processor (1404) can be used to determine a set of representative sequences for each sequence cluster that can be stored in memory (1402). The processor (1404) can be configured to determine the distance between the representatives and the new sequence to determine whether the corresponding cluster is retained for further analysis.

The computing device 1400 can generally be any electronic device capable of network communication. For example, and without limitation, the computing device 1400 can be a server, personal computer, laptop, personal data assistant, cellular telephone, smart-phone device, tablet computer, wireless device, and/or kiosk. The computing device 1400 can include one or more components or modules that operate based on software and/or hardware. For example, the computing device 1400 can include a device processor, a device storage component and a device interface component. The device processor can generate a request for access to resources available remotely from the computing device 1400 and/or a request to change an access level for a user, a group of users or a resource.

Resources available to the computing device 1400 can include one or more software applications and/or hardware components. These resources can be stored remotely from the computing device 1400. These resources can be provided to the computing device 1400 via the client interface component. The client interface component can provide a communication interface for receiving and/or transmitting data with external components and/or other devices (e.g., via a USB connection, serial port connection, parallel port connection, HDMI port connection, radio-frequency connection, Bluetooth™ connection, a wireless connection, a mobile network connection, audio data connection, video data connection and any other data connections).

The software applications can include computer programs that can provide functionality of the computing device 1400 or enable functionality of the computing device 1400. The software applications can also operate with or enable the hardware components to provide functionality to the computing device 1400. For example, the software applications can include, without limitations, e-mail client applications, messaging applications, social networking applications and/or gaming applications.

The hardware components can include any physical components or devices that can be available for use by the computing device 1400. For example, the hardware components can include a storage component (e.g., a hard disk drive, a random-access memory, and/or other computer data storage components), a navigation component (e.g., a Global Positioning System (GPS)), a multimedia component (e.g., a sound card, a video card, etc.), one or more user interface components (e.g., a touch screen, a keyboard, a display, etc.), and/or other components for providing additional functionalities to the computing device 1400 (e.g., a motion detection module including a Gyroscope, etc.).

FIG. 15 is a schematic representation of the overall RESL algorithm. Barcode sequences are initially subjected to quality filters prior to Hidden Markov Model alignment. In turn, a B-Tree Index is constructed to improve the performance of initial Single Linkage pre-clustering. Precluster groups then undergo Haplotype Compression to reduce over sampling. Finally, cluster refinement that utilizes Markov Clustering and Silhouette Indexing results in the determination of final clusters.

1. Alignment:

A profile Hidden Markov Model [43] of the COI protein [44] may be used to align the input sequences.

2. Index Construction:

To improve the computational performance of initial clustering, a binary tree (B-tree) index may be generated based on sequence composition (% GC) for each sequence. Selection of GC is based on the high variability of this feature in COX1 sequences; other gene markers may exhibit broader ranges in other combinations or single base composition. Choice of index feature should minimize the number of indexes (single bases result in 4 indexes) while maximizing the range and broad distribution of data across indexes. In some embodiments, each sequence is scanned with a sliding window of length W (300 bp) at I (10 bp) increments with % GC computed for each window. The upper bound and lower bound for % GC is stored in a B-Tree index to speed bounded retrieval operations. Sequences with divergence below T must also have a % GC delta within T, as such the search space for distance calculations are greatly reduced when composition varies as is the case for the COX1 gene.

3. Initial Clustering:

Single linkage clustering is an agglomerative clustering strategy where entities are joined based on whether their distance is below a threshold T. The distance between different nucleic acid sequences can be determined in different ways. For example, the percentage divergence between two aligned sequences can be calculated. For the sequences, ACTTG and ACTTA the percentage divergence would be ⅕=20%. In other words, the two sequences would be aligned and all the nucleotides would match except for the last one which is G in one sequence and A in the other. Alternatively, a K-mer distance metric could be used. Regardless of the approach taken, a normalized distance value could be generated (ranging from 0 to 1).

In this implementation, clustering on the aligned sequence data was performed but it can also be performed on unaligned data by generating pairwise alignments prior to distance calculation. Clustering sequences ordinarily requires the generation of a distance matrix for all pairs of sequences followed by a clustering step where sequences are grouped based on a pre-selected distance threshold [45, 46]. However, this is both computationally and memory intensive. RESL performs distance calculations and clustering concurrently, employing the transitive property to avoid distance determinations for sequences that are certain to possess a divergence above the threshold. This strategy is implemented by flushing all clusters to disk, and retaining one or more representative sequences, depending on the diameter of the cluster (i.e. traversal of a minimum spanning tree that has a length less than the distance threshold only results in one representative sequence), for each cluster and inter-cluster distance statistics in active memory, loading sequences for matched clusters into memory as necessary.

Representative sequences for a candidate cluster can be selected through a depth-first traversal of a minimum spanning tree. Traversal can start at the first member of the cluster and a representative sequence can be sampled at every T. Representative sequences for a candidate cluster can be selected such that representative sequences are approximately the same distance from each other, in this case, the threshold distance. As such, small clusters (with a diameter less than the threshold) may only have a single representative sequence. Representatives for large clusters are produced through organization of the sequences in a candidate cluster into a minimum spanning tree, a network structure representing the shortest path between any two sequences, and sampling from the tree. A minimum spanning tree can be generated for each candidate cluster using Prim's Algorithm [47] and can be updated with the addition of sequences to the candidate cluster. To test the membership of a new sequence to existing clusters a series of steps can be taken to reduce the search space:

i. The upper and lower bound GC % for the input sequence can be calculated, and the B-Tree is searched for clusters with representative sequences of GC % ranges within T of the input sequence. This operation returns pointers to a subset of the existing clusters.

ii. The sequence divergence between the new sequence and the representative(s) of clusters returned from step 1 can be calculated to identify matches. In some embodiments, where threshold T=2.2%, if the new sequence's distance to any existing cluster is more than twice T (i.e. >4.4%), it may be recognized as the founder of a new cluster. If, on the other hand, the distance to any representative sequences from any clusters is less than twice T (i.e. <4.4%), all members of the closest cluster(s) can be retrieved from disk to determine if the input sequence matches shows a distance to any of the cluster members with a distance of less than T. This approach can considerably reduce computational and memory requirements without compromising accuracy, and analysis can be further expedited by moving clusters to disk when they have seen no activity (=gained new members) for a number of cycles.

iii. If the input sequence shows a distance of less than T to a member of a cluster, the input sequence joins that cluster. In the event that the input sequence shows a distance of less than T to members of multiple clusters, those clusters are merged and the input sequence joins the resultant cluster.

For some clusters, each previously classified nucleic acid sequence in that cluster will be closer to other previously classified nucleic acid sequences in that cluster than to any previously classified nucleic acid sequences in other clusters. However, this need not be true for all clusters. For example, say that a first cluster neighbors a second cluster and that the first cluster has a relatively large intra-cluster diameter such that the largest distance between sequences in the first cluster exceeds the distance between the at least one sequence in the first cluster and another cluster in the second cluster. However, even in the second case, for each sequence in the first cluster, that sequence will be closer to another previously classified sequence in the first cluster than it is to any sequence in another cluster.

TABLE 1
Eight datasets used to test the performance of algorithms for
OTU delineation.

| | | | Source |
|---|---|---|---|
| | | | Pub- |
| Datasets | GenBank Accessions | Records on BOLD | lication |
| Birds | Subset of 1589 from | dx.doi.org/10.5883/ | 64 |
| (Argentina) | [FJ027014: FJ028607; | DS-AVESNT1 | |
| | HM37669: HQ955631] | | |
| Birds | Subset of 1936 from | dx.doi.org/105883/ | 65 |
| (North | [DQ432694: DQ434845] | DS-AVESNA1 | |
| America) | | | |
| Bees | Subset of 231 from | dx.doi.org/10.5883/ | 66 |
| (Ireland) | [JQ909638: JQ909880] | DS-BEEIRE1 | |
| Fishes | Subset of 753 from | dx.doi.org/10.5883/ | 15 |
| (Australia) | [DQ107581: DQ108334] | DS-FISHAUS1 | |
| Fishes | Subset of 1359 from | dx.doi.org/10.5883/ | 67 |
| (Canada) | [EU522398: EU525162] | DS-FISHCAN1 | |
| Geometrid | Subset of 649 from | dx.doi.org/10.5883/ | 53 |
| Moths | [GU654862: GU707400; | DS-GEOBAV1 | |
| (Bavaria) | HM37669:HQ955631] | | |
| Moths and | Subset of 11144 from | dx.doi.org/10.5883/ | 68 |
| Butterflies | [AF549607AF549807; | DS-LEPNA1 | |
| (North | EF380034: EF380093 | | |
| America) | GU087155: GU439197; | | |
| | HQ964351: HQ964544] | dx.doi.org/10.5883/ | N/A |
| Plusiinae | Subset of 1191 from | DS-PLUSNA1 | |
| Moths | [JN276649 :JN276703; | | |
| (North | JF842288: JF5860650; | | |
| America) | HQ682249: HQ971874; | | |
| | HM375761: HM907009; | | |
| | GU087601: GU803711; | | |
| | FJ412191: FJ412987; | | |
| | AF549706: AF549755; | | |
| | KC846141: KC846779] | | |

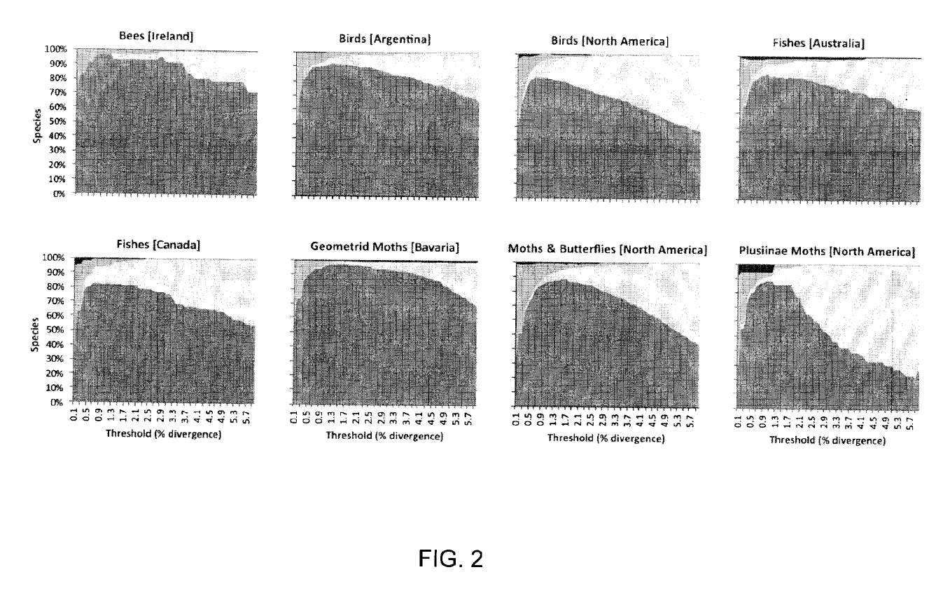

The implementation of single linkage clustering may require the selection of a threshold parameter, T, which represents the level of sequence divergence for the designation of OTUs. Early work [13] suggested that a threshold value of 2% was effective because most specimens showing more than this level of divergence represented different species, while those with less divergence were usually conspecific. However, this issue was examined in more detail by inspecting the patterning of OTU recovery with variance in the distance threshold for eight datasets (Table 1). Sixty single linkage cluster analyses were generated for each dataset by stepping the distance threshold parameter by an increment of 0.1% across the range from 0.1%-6.0%. The OTUs recovered at each threshold were subsequently evaluated for their concordance with recognized species boundaries (FIG. 2). These analyses revealed that maximal concordance was achieved by thresholds that varied from a low of T=0.7% (in North American birds) to a high of T=1.8% (in Bavarian moths). It also showed that performance, as measured by the number of correctly recognized species, dropped steeply when the threshold deviated on either side of optimality. Thresholds higher than optimal inflated the number of cases where members of different species were merged in a single OTU, while thresholds lower than the optimal value increased the cases where members of what are thought by current taxonomy to be a single species were split into two or more OTUs. Based on these analyses, a threshold (T) of 2.2% was adopted as it represents the upper 99% confidence limit for the optimal thresholds in the eight test datasets ( x̅=1.26, SD=0.40). Its adoption may lead to the merger of some distinct clusters, but such cases are addressed in the fifth step of the analysis.

4. Haplotype Compression:

In some embodiments, RESL may comprise compressing each OTU generated through Single Linkage Clustering down to single representatives for each haplotype based on 0% divergence and 500 bp of overlap to reduce the impact of sampling bias on cluster refinement. This has the added benefit of speeding computation as it reduces the number of data points involved in calculations. Sampling bias occurs where some haplotypes within a cluster are oversampled. Bias in sampling creates a problem for MCL, an approach that infers separation in data points based on connectedness. Over sampled haplotypes artificially inflate the number of edges in a graph representation. Haplotype compression can thus reduce the impact of sampling bias where a single haplotype generates multiple data points influencing the clustering results in downstream analysis.

5. Cluster Refinement (Silhouette Optimality Criterion for MCL Clustering):

To select the inflation parameter for the MCL algorithm at the refinement phase, a range of values are attempted (1.0-2.4, at increments of 0.2). To identify an inflation parameter for MCL in refining a candidate cluster, the Silhouette coefficient is calculated for any subdivisions of a candidate cluster generated through MCL. The inflation parameter with the highest Silhouette can be selected as a solution.

Specifically, in some embodiments, RESL may further employ MCL with an optimality criterion to verify and, where necessary, refine the structure of any OTU with three or more members showing some sequence variation. OTUs whose members lack sequence variation and those with just one or two members may not be further partitioned through MCL so they may not be reconsidered until their membership grows. In essence, this step may examine each OTU selected for secondary analysis to determine if the MCL algorithm [36] places its members in two or more discrete sequence clusters. Under this approach, clusters whose members show high sequence variation, but lack discontinuity may remain as a single OTU, while those whose sequence variation shows clear internal partitions may be assigned to two or more OTUs, even if their separation is less than 2.2%. The MCL step may enable the separation of sequence clusters that would be overlooked by a fixed threshold, but does not produce rampant amalgamation or fragmentation of clusters. Clusters may not be at risk of merger unless they sit close to the sequence threshold. For example, if a cluster is founded by a single individual with 6.0% sequence divergence from its nearest-neighbour, amalgamation may not occur unless further sampling reveals an extraordinary level of variation that bridges the sequence divide. Cases can occur where specimens originally assigned to the same cluster are separated when further sampling reveals two distinct sequence clusters. In this case, the founder of the first cluster may retain its membership, while an audit trail tracks information on the original cluster designation for those records that move.

The MCL algorithm may delineate clusters through simulated random walks in the section of the graph surrounding each OTU selected for analysis. This walk may be achieved through the repeated application of two functions, expansion and inflation, to a stochastic matrix, M, representing the probability of a random walker moving from one node (=sequence) in the graph to another. Expansion can enhance traffic between nodes, while inflation can raise the probability of walks within highly connected regions. The iteration of expansion and inflation may ultimately result in stable segmentation of the graph. The segments present at this equilibrium point may be treated as separate OTUs. Mathematical details follow:

M is a non-negative matrix with the property that each of its columns sums to 1. Each column j in the stochastic matrix corresponds with node j (=sequence j) of the graph. Row entry i in column j (i.e. matrix cell Mᵢⱼ) corresponds to the probability of walking from node j to node i (i.e. from sequence j to i). The stochastic matrix may be initialized by normalizing the edge weights (=sequence similarity) associated with each node in the graph such that the probability of walking from node j to node i is defined by both the similarity of the two sequences and the similarity between node j and all other nodes.

Expansion involves taking the power of the stochastic matrix using the normal matrix product; in this case, squaring the matrix.

Inflation generates the Hadamard power of the matrix, followed by a scaling step to return matrix elements, which represent probability values, to the range of 0-1. An inflation parameter, r, is employed to tune the coarseness of the clusters. It can range from 1.0-10.0 with higher values producing finer-grained clusters. RESL optimizes the inflation parameter for each of the single linkage OTUs selected for refinement. It does this by analyzing each using MCL with r values ranging from 1.0-2.4 at 0.2 increments before selecting the value producing the highest Silhouette index. Other embodiments of the invention may use other ranges of r values at different increments.

### 2.2 OTU Pipeline on BOLD

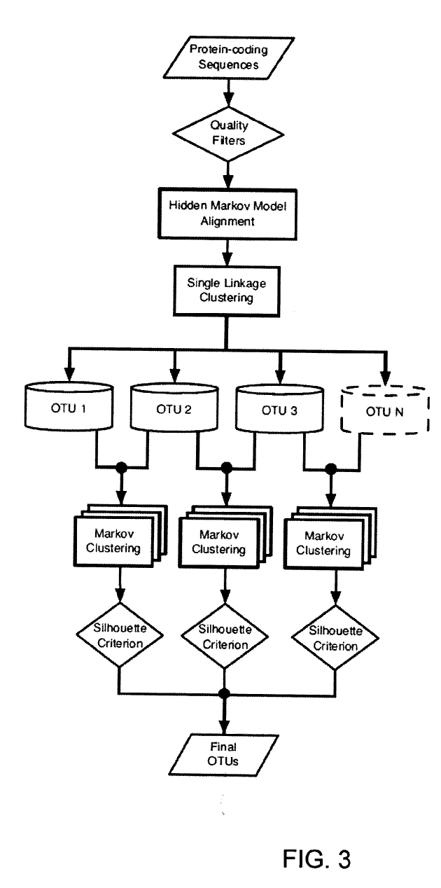

A six-stage workflow on BOLD employs RESL to cluster sequences and to assign each newly collected sequence to an OTU (FIG. 3).

1. Quality Checks:

Each new sequence may be first filtered for quality, a process that, in some embodiments, excludes any record with less than 500 bp coverage for the barcode region of COI or with more than 1% ambiguous bases. If a sequence meets these quality requirements, it may then be checked for reading frame shifts as indicated by stop codons or improbable peptides given the COI profile [44]. Because sequences showing these attributes are likely to derive from pseudogenes, they may be excluded. Sequences may then be screened to ensure that they do not derive from bacterial (e.g. Wolbachia) or certain external (e.g. human, mouse) contaminants by matching the sequence recovered from each specimen against a reference library of bacterial and selected vertebrate sequences. Finally, when a sequence record originates from the assembly of two or more shorter sequences, the Bellerophon package [48] may be utilized to check for possible chimeras that would arise if the component sequences inadvertently (e.g. contamination, laboratory error) derived from two different taxa.

2. Sequence Alignment:

In some embodiments, each sequence that passes all quality checks may be translated to amino acids and aligned to a Hidden Markov Model (HMM) of the COI protein [43]. The aligned amino acids may be back translated to nucleotides to produce a multiple sequence alignment.

3. Single Linkage Clustering:

The next stage of analysis may group all sequences with a pairwise distance less than 2.2%, merging previously established groups when sequences are encountered that bridge a former sequence gap. The outcome is deterministic for any set of sequences, and the resulting clusters are not affected by their order of entry. Under this analytical regime, no member of any cluster is closer than the threshold (T=2.2%) to any sequence in another cluster, but cluster diameters may be greater than the threshold.

4. Haplotype Compression:

In some embodiments, OTUs are compressed by reducing haplotypes based on 0% sequence divergence where sequences overlap by at least 500 bp.

5. Markov Clustering:

In some embodiments, the cluster refinement stage takes the OTUs identified by single linkage clustering as input. When an OTU shows low distance (<4.4%) from another OTU(s), these neighbors may be collapsed into a single unit before MCL clustering is used to allow more rigorous validation of their separation. MCL may be run on the targeted OTUs, using inflation parameters ranging from 1.0-2.4 at intervals of 0.2, producing 8 refinement options for each OTU analyzed. In other embodiments of the invention, the inflation parameter may have different ranges and different interval periods.

6. Silhouette Criterion:

In some embodiments, the final stage takes the candidate clustering schemes generated by the 8 inflation parameter values with Markov clustering and generates a Silhouette score for each. The scheme with the maximum score may be selected and reported while alternate schemes may be discarded.

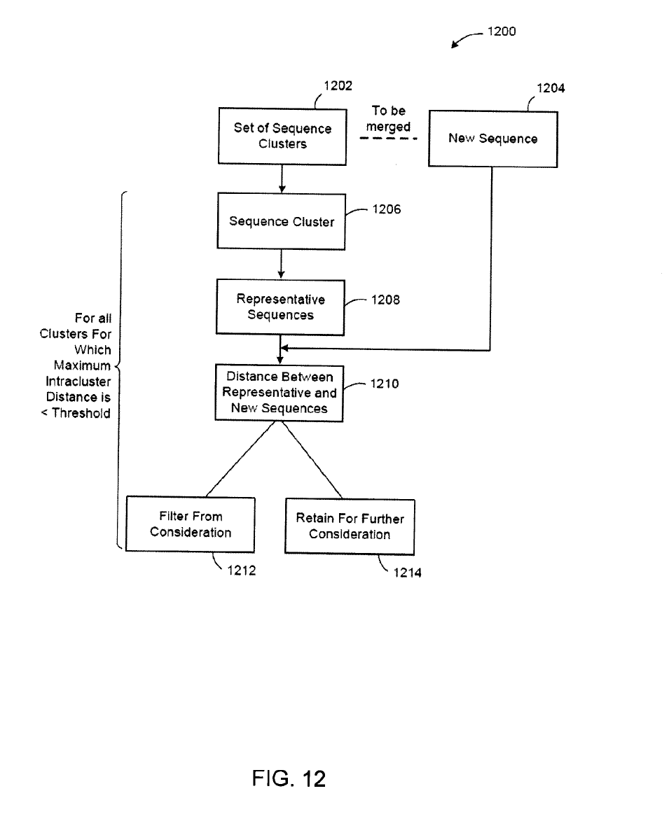

FIG. 12 is a schematic representation of one possible embodiment (1200) of the disclosed method in which previously generated sequence clusters (1202) are filtered during a process of merging a new sequence (1204) with the set of previously generated sequence clusters (1202). For each sequence cluster (1206) for which the maximum intra-cluster distance is less than the threshold, one or more representative sequences (1208) are retrieved. Each sequence cluster comprises a plurality nucleotide or amino acid sequences and the number of representative sequences is less than the total number of sequences in the cluster. The maximum intra-cluster distance is the largest pairwise distance between two sequences in the cluster. The distance between the representative sequences and the new sequence is then determined (1210) and, if the computed distance is greater than twice the maximum intra-cluster distance threshold, the cluster is filtered from further consideration (1212). If the distance is less than twice the maximum intra-cluster distance threshold, then the cluster is retained for further analysis (1214).

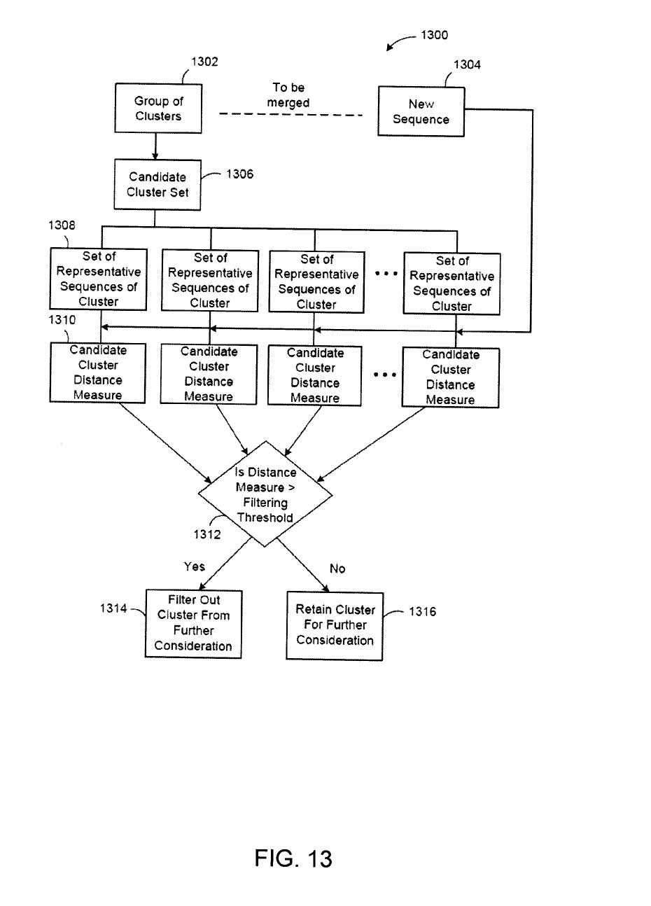

FIG. 13 is a schematic representation of one possible embodiment (1300) of the disclosed method in which previously generated clusters are filtered during a process of merging a new sequence (1304) with a group of clusters (1302). A candidate cluster set (1306) is first determined. The candidate cluster set includes a plurality of candidate clusters and each candidate cluster comprises a plurality of previously classified nucleotide or amino acid sequences. Each candidate cluster has a maximum intra-cluster distance that is less than a pre-defined maximum intra-cluster distance threshold. The maximum intra-cluster distance of each candidate cluster is a measure of the distance between the two previously classified nucleotide or amino acid sequences that are the furthest from each other in the plurality of previously classified nucleotide or amino acid sequences of the candidate cluster. The processor of a computer system is then used to determine a plurality of sets of representative sequences (1308), by determining, for each of the candidate clusters in the candidate cluster set, a set of one or more representative sequences, wherein for at least one candidate cluster, the number of representative sequences in the set of one or more representative sequences of the candidate cluster is less than the number of previously classified nucleotide or amino acid sequences in the plurality of previously classified nucleotide or amino acid sequences of the candidate cluster. The processor is then used to determine a plurality of candidate cluster distance measures (1310), by determining, for each of the candidate clusters in the candidate cluster set, a candidate cluster distance measure between the new nucleotide or amino acid sequence and the candidate cluster, wherein the candidate cluster distance measure between the new nucleotide or amino acid sequence and the candidate cluster is determined by determining the distance between the nucleotide or amino acid sequence and the set of one or more representative sequences of the candidate cluster. The processor is used to filter out from further consideration (1314) each candidate cluster in the candidate cluster set if and only if the associated candidate cluster distance measure of the candidate cluster is greater than a pre-defined filtering threshold (1312), and retaining all other candidate clusters in the candidate cluster set for further consideration (1316).

### 2.3 Performance Comparison

TABLE 2
Properties of the eight datasets used in testing performance of
algorithms for OTU delineation.

| | | | | Mean Max- | Mean |
|---|---|---|---|---|---|
| | | | Sequences | Intraspecific | N-N |
| Datasets | Species | Sequences | per Species | Distance | Distance |
| Birds | 497 | 1589 | 3.2 | 0.39 | 8.20 |
| (Argentina) | | | | | |
| Birds | 575 | 1936 | 3.4 | 0.43 | 6.70 |
| (North | | | | | |
| America) | | | | | |
| Bees | 56 | 231 | 4.1 | 0.48 | 8.87 |
| (Ireland) | | | | | |
| Fishes | 212 | 753 | 3.6 | 0.50 | 8.73 |
| (Australia) | | | | | |
| Fishes | 190 | 1359 | 7.2 | 0.40 | 7.68 |
| (Canada) | | | | | |
| Geometrid | 298 | 649 | 2.2 | 0.36 | 7.11 |
| Moths | | | | | |
| (Bavaria) | | | | | |
| Moths and | 1327 | 11144 | 8.4 | 0.77 | 5.96 |
| Butterflies | | | | | |
| (North | | | | | |
| America) | | | | | |
| Plusiinae | 69 | 1182 | 17.3 | 0.52 | 3.53 |
| Moths | | | | | |
| (North | | | | | |
| America) | | | | | |

Eight datasets were employed to test the performance of the five algorithms available for OTU recognition (Table 1). These datasets include four taxonomic groups (birds, fishes, moths and butterflies, bees) from two climatic regimes (temperate, tropics). Global barcode coverage is not available for any major taxonomic group, but these datasets examine taxon assemblages at both regional and continental scales. Each dataset only includes records that were associated with a valid taxonomic name; sequences associated with interim names were excluded. Seven of the datasets derive from a published study and have been placed in datasets on BOLD (Table 1), while the eighth includes new records which provide comprehensive coverage for the North American representatives of the Plusiinae, a moth subfamily (dx.doi.org/10.5883/DS-PLUSNA1 or GenBank accessions in Table 1). These eight datasets have varying sampling densities, with the average number of specimens per species ranging from 2.2 to 17.3 (Table 2). Mean intraspecific variation and nearest-neighbour distances may also show substantial heterogeneity among the species in each dataset. In testing the performance of the algorithms, the taxonomic assignment for each record in these trial datasets was treated as a ‘truth’. However, it is important to recognize that these assignments may be imperfect, even for these well-studied groups.

The results generated by RESL were compared with those obtained through analysis of the same test datasets with the other four algorithms although GMYC was not examined for the largest dataset (because of its long run time). CROP and jMOTU incorporate sequence alignment into their clustering process, while ABGD and the phylogeny reconstruction step for GMYC require pre-aligned sequences which were generated with the MAFFT package [49]. GMYC also requires the construction of a bifurcating, ultrametric tree which was generated using BEAST [50]. Prior to phylogeny reconstruction, the most appropriate model of evolution was separately estimated for each dataset from alignments using jModelTest [51]. A GTR model with gamma-distributed substitution rates was selected for all datasets along with an estimated proportion of invariant sites. A Yule prior was used and the remaining model parameters were estimated from the data. A Bayesian search was performed on each dataset for 10M generations logging every 1K. The resultant logs were analyzed in TREEANNOTATER [50], selecting the tree with the maximum clade credibility while retaining node heights. The SPLITS package (http://r-forge.r-project.org/projects/splits) in R was utilized for GMYC calculations. GMYC was performed using the single-threshold strategy and default scaling parameters. Clusters were extracted from GMYC data objects using the APE package [52]. The other four algorithms require the specification of input parameter values that control the granularity of clustering. Parameters for ABGD, CROP, and jMOTU were selected to maximize the number of clusters that matched existing species (ABGD: p=0.005, P=0.1, n=20, d=1, s=0.1; CROP: 1=0.36, u=0.6, m=15; jMOTU: t=12 bp). Parameter selection for jMOTU, ABGD, and CROP was accomplished by testing a range of parameter values for each method before selecting those values that maximized the overall MATCHES across the eight test datasets. When multiple parameter values resulted in the same maximum, the values minimizing the number of MERGES, SPLITS, and MIXTURES were selected, as the performance criterion involved selection of the algorithm that best recovered the species boundaries recognized by current taxonomy, a condition that can be satisfied by maximizing MATCHES and minimizing the other categories.

### 3. RESULTS

### 3.1 RESL Performance

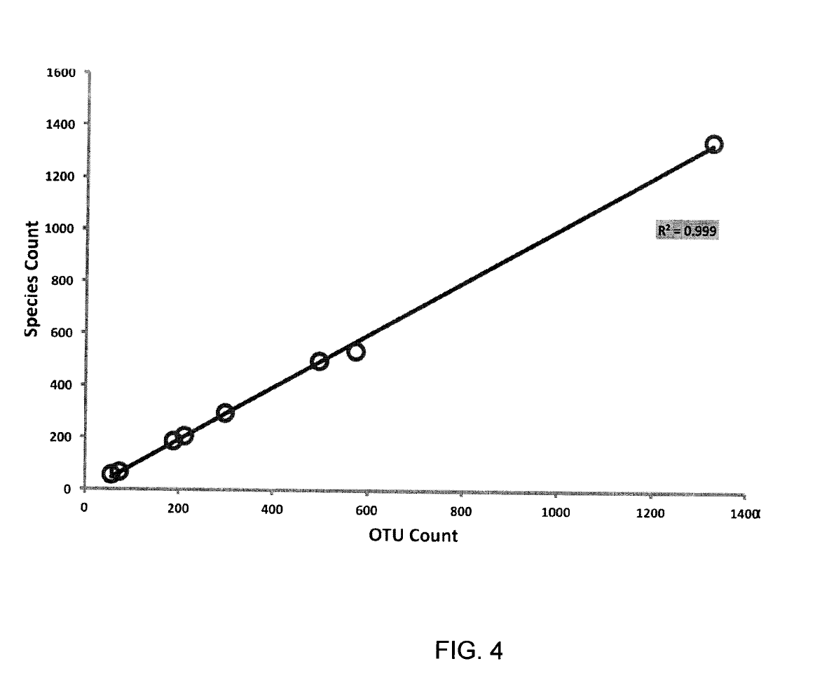

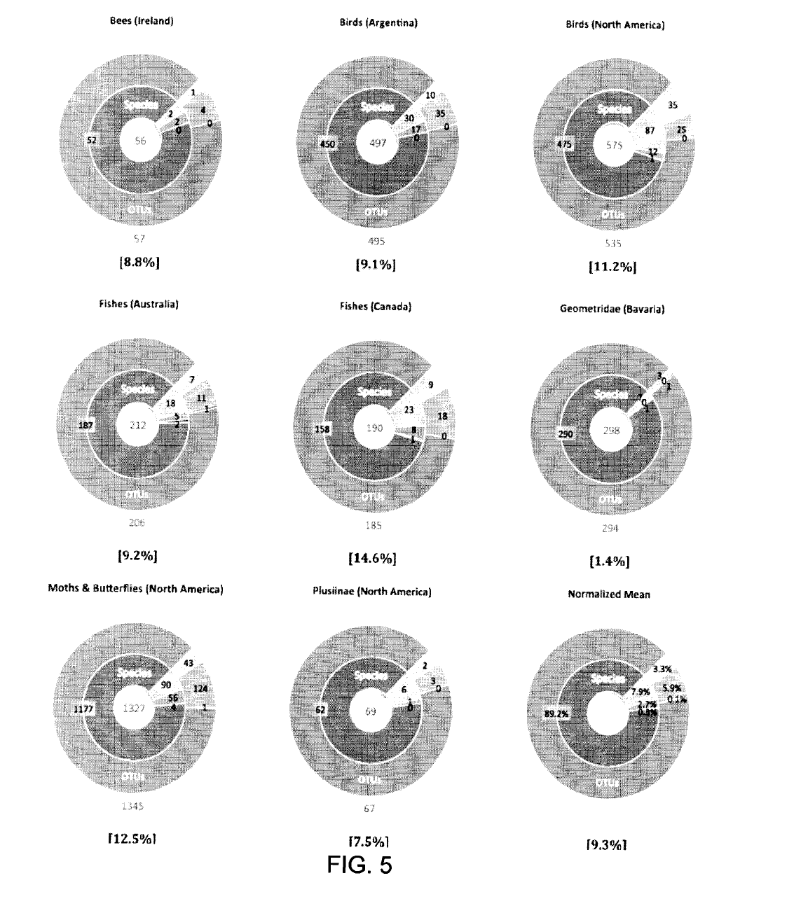

Each of the eight test datasets was analyzed with RESL using the standard parameters (Single linkage clustering T=2.2%; Markov clustering, r=1.0-2.4). The OTU counts resulting from this analysis showed extremely high correlation (R²=0.999) with the number of species in the datasets (FIG. 4). A more rigorous evaluation of the performance of RESL was accomplished by mapping known species onto the OTUs (FIG. 5), and placing each species into one of the four categories (MATCHES, SPLITS, MERGES, MIXTURES). For example 52 of the 56 bee species from Ireland were assigned to a unique OTU (52 MATCHES), two were merged into an OTU (2 MERGES) and two other species were split into four OTUs (2 SPLITS). When viewed across the eight datasets, RESL performed well, with 89.2% of species in the MATCHES category, 2.7% in SPLITS, 7.9% in MERGES, and 0.3% in MIXTURES. The relatively high incidence of MERGES may reflect the fact that RESL treats sequence divergences conservatively, pooling taxa showing low divergence rather than partitioning them. The low incidence of SPLITS in the Bavarian geometrid study may reflect the fact that 14 species with the deepest intraspecific divergence were excluded from consideration in that paper to await detailed taxonomic study [53].

### 3.2 Performance Comparison of Algorithms for OTU Recognition

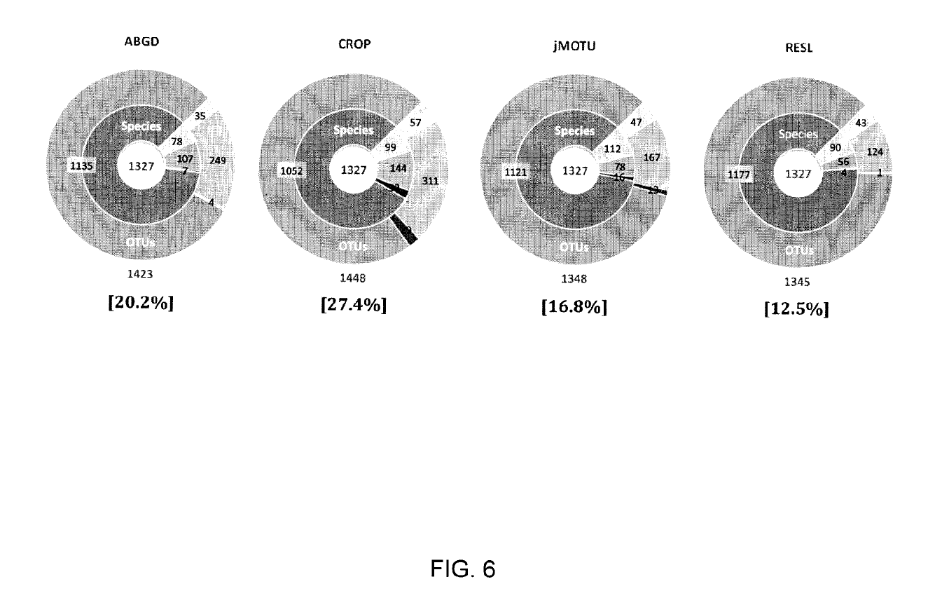

Taxonomic Concordance Trials: FIG. 6 compares the performance of ABGD, CROP, jMOTU, and RESL in analysis of the largest dataset, the Lepidoptera of Eastern North America. Results for GMYC are unavailable because analysis was incomplete after the established time limit of two weeks. However, the performance of GMYC and RESL for other datasets is compared later. CROP, jMOTU, and RESL produced an OTU count that closely approximated the actual species number (1327), but the ABGD algorithm inflated it by about 100 species, reflecting its tendency to split sequence clusters. The tally of OTUs involved in MERGES, MIXTURES and SPLITS provides a measure of the departure of the OTUs recovered by each algorithm from recognized taxonomy. Viewed from this perspective, RESL was the top performer (12.5% taxonomic discordance) for the Lepidoptera of North America dataset, while CROP was weakest (27.4%).

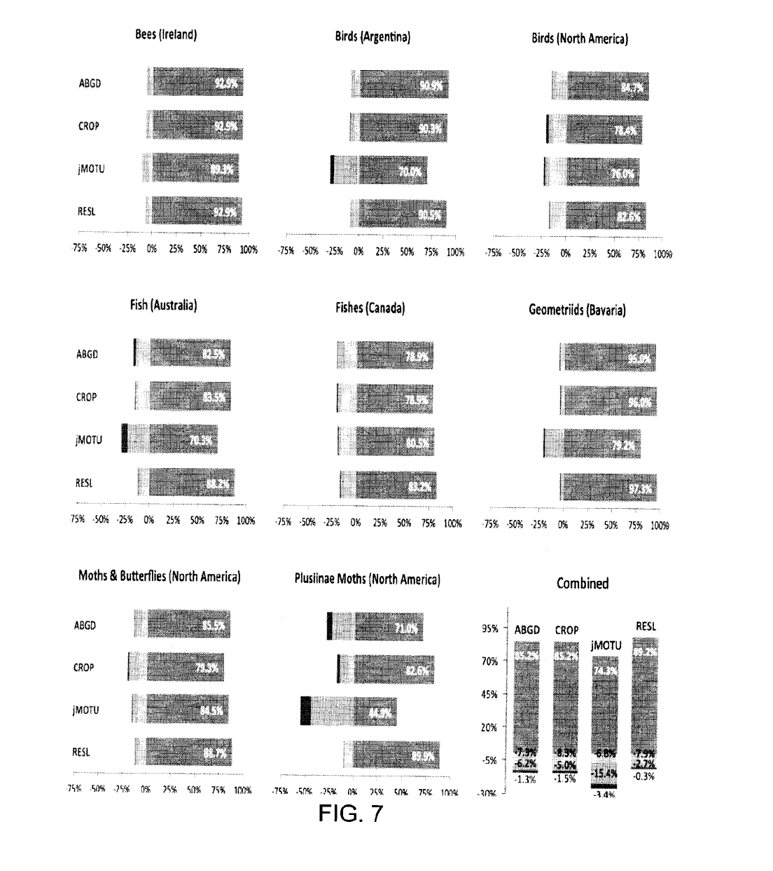

When this comparison was extended to all eight test datasets, RESL demonstrated the strongest performance as it either tied or achieved top ranking in MATCHES for 6 of the 8 datasets (FIG. 7). On average, it scored 89.2% MATCHES versus 85.2% for ABGD, 85.2% for CROP, and 74.3% for jMOTU. In the two cases where it was not the top performer (Birds of the Argentina, Birds of North America), it was a close second. RESL performed considerably better than the other three approaches on the Plusiinae, the dataset with the largest number of specimens per species and the narrowest barcode gap (Table 2), reflecting its capacity to effectively delineate cluster boundaries in groups with low interspecific distances. RESL also showed more consistency in MATCHES (range=82.6-97.3%, SD=4.8%) than the next best result with CROP (range=78.4-95.6%, SD=6.9%). Finally, RESL showed the lowest incidence of SPLITS (x=2.7%) and MIXTURES ( x̅=0.3%) with the next best option, CROP, showing nearly twice as many SPLITS and over three times as many MIXTURES.

In order to evaluate the quality of clustering, the result of clustering may also be compared against the ground truth using the F-Measure [39]. The F-Measure metric combines precision and recall concepts from information retrieval.

$$Recall ( i , j ) = \frac{{n}_{ij}}{{n}_{i}}$$

$$Precision ( i , j ) = \frac{{n}_{ij}}{{n}_{j }}$$

Where nᵢⱼ is the number of objects of class i in cluster j, nⱼ is the number of objects in cluster j, and nᵢ, is the number of objects in class i. It is defined as the combination of Recall and Precision:

$$F ( i , j ) = \frac{2 Recall ( i , j ) Precision ( ij )}{Precision ( i , j ) + Recall ( i , j )}$$

The performance of the four algorithms was compared using the F-Measure [39] index which returns values from 0 to 1 with 1 indicating perfect reproduction of the ground-truth partitions. RESL performed best or tied for top score in 7 of 8 datasets with this test (Table 3).

TABLE 3
A comparison of the performance of four clustering algorithms
with the F-Measure.

| | F-Measure | | | |
|---|---|---|---|---|
| | ABGD | CROP | jMOTU | RESL |
| Birds (Argentina) | 0.86 | 0.86 | 0.79 | 0.86 |
| Birds (North America) | 0.83 | 0.82 | 0.82 | 0.83 |
| Bees (Ireland) | 0.92 | 0.92 | 0.90 | 0.92 |
| Fishes (Australia) | 0.88 | 0.88 | 0.83 | 0.88 |
| Fishes (Canada) | 0.94 | 0.96 | 0.97 | 0.95 |
| Geometrid Moths | 0.71 | 0.71 | 0.62 | 0.71 |
| (Bavaria) | | | | |
| Moths & Butterflies | 0.88 | 0.88 | 0.90 | 0.90 |
| (North America) | | | | |
| Plusiinae Moths | 0.87 | 0.90 | 0.85 | 0.93 |
| (North America) | | | | |

Time Trials:

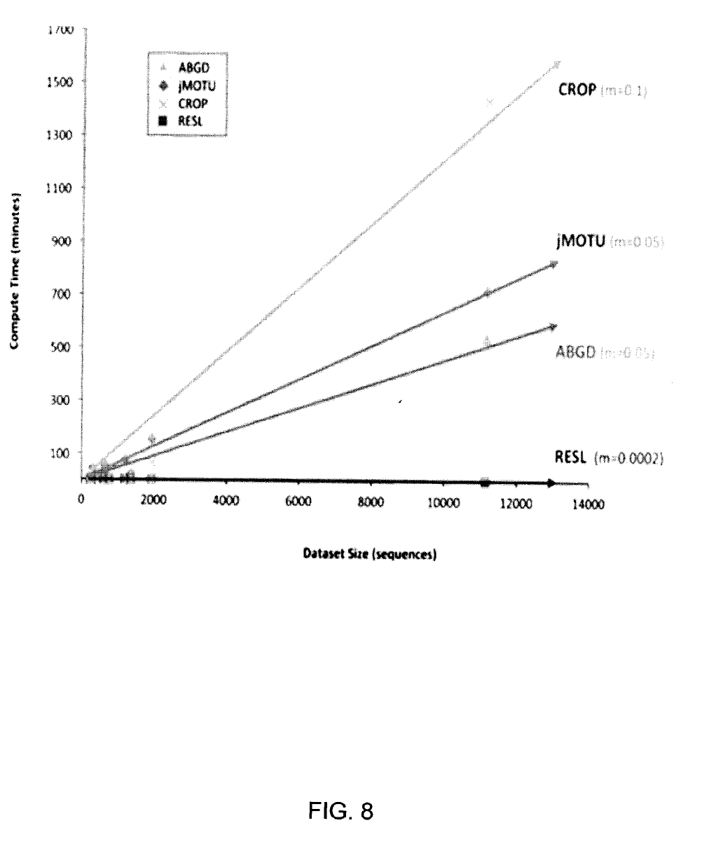

The run-time for RESL was compared with those for the other three algorithms on a 2012 model iMac with an i7 Intel processor and 8 gigabytes of memory. CROP, jMOTU, and RESL could take advantage of the four CPU cores on this system and were allowed to do so. This analysis revealed that run times for all four algorithms rose in an almost linear fashion with increasing size of the dataset (FIG. 8). However, RESL was more than 100 times faster than any of the other methods, completing the largest dataset (11.1K sequences) in less than 2 minutes versus 541 minutes for the next fastest option (ABGD). More importantly, it may have showed the closest approach to linear computational complexity, a feature critical to the analyses of the barcode sequences on BOLD (1.81M circa April 2013).

Performance Comparison of GMYC and RESL:

GMYC differs from the other algorithms as it utilizes a model of speciation to generate OTUs and requires a phylogeny rather than sequences as input. In order to generate OTU assignments, GMYC requires time for both phylogeny reconstruction and GMYC calculation. When it was applied to the largest dataset (Lepidoptera of North America), GMYC failed to complete the phylogeny reconstruction step within the two week limit set in the study design (approximately another week would have been required to complete this step). As such, the performance of GMYC and RESL was only compared for 7 datasets.

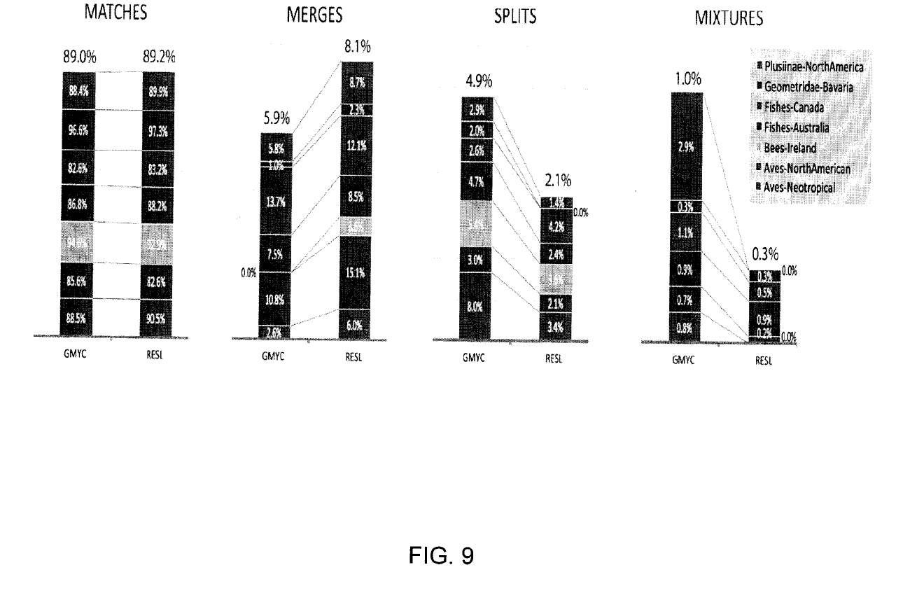

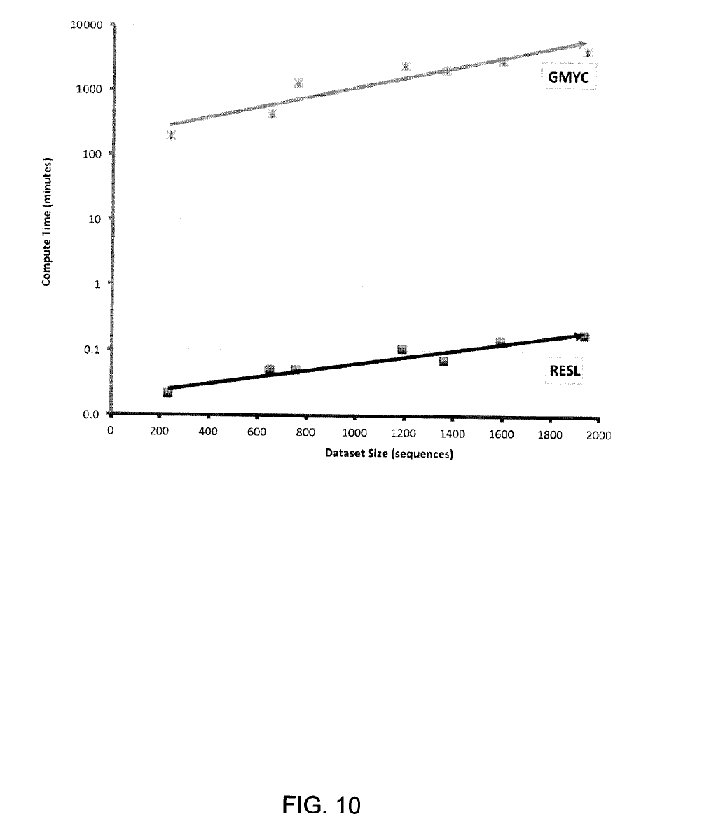

GMYC and RESL showed similar overall taxonomic performance (FIG. 9), although RESL produced slightly more MATCHES (+0.2%), fewer SPLITS (−2.8%) and fewer MIXTURES (−0.7%), while GMYC generated fewer MERGES (−2.2%). Additionally, both algorithms showed a similar level of consistency in MATCHES (SD=4.8%). Although their taxonomic performance was congruent, there was a dramatic difference in their run times; GMYC required 5000 times longer than RESL to complete the OTU assignments for the 7 test datasets (FIG. 10).

### 3.3 Implementation

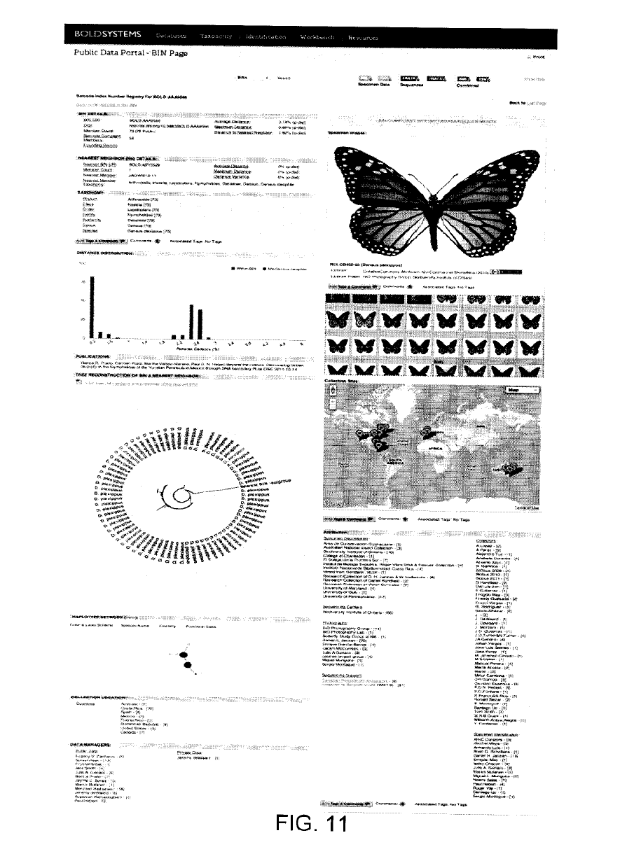

Because of its strong taxonomic performance and speed, RESL was adopted to generate OTUs for the barcode sequences on BOLD [42]. Each of the OTUs resulting from this analysis was subsequently assigned a unique alphanumeric code with a standard structure (BOLD: 3 letters, 4 numbers). The overall informatics system supporting the indexing, storage, and retrieval of the OTUs produced through this application of RESL was termed the Barcode Index Number (BIN) System. It provides an index of unique identifiers, a database of specimens belonging to each BIN with their associated metadata, and an interface facilitating data access. The module employs Java for middleware, PHP and Javascript for the interface, and MongoDB (mongodb.org) as the database engine. The BIN pipeline analyzes new sequence data for the barcode region as they are uploaded to BOLD. Sequences that establish a new BIN add an entry to the BIN index, while sequences assigned to an existing BIN contribute their metadata to it. Each BIN may be presented as a single page that exposes the aggregate data for its members. However, each BIN page may hold sequence information private until data release is authorized by the submitter. Aside from revealing the gestalt of BIN pages, FIG. 11 provides a sense of RESL's performance. For example, specimens of Danaus plexippus show just 1.88% divergence from their nearest neighbour, D. cleophile, but the two taxa were assigned to different BINs because of the clear break between intra- and interspecific divergence.

Because the BIN system gains power with increasing species coverage, records have been analyzed which are not fully compliant with the DNA barcode standard. Although all records in the BIN registry meet the sequence standard (>500 bp, <1% n), some lack the specimen data required to qualify for formal barcode designation. These non-compliant records are a minority because 1.68M of the 1.81M records derives from BOLD and nearly all (99.7%) have the required linkage to a voucher specimen and geospatial data. However, many of the 0.12M records from GenBank lack connection to a voucher specimen and only 14.5% possess country information. BIN pages that include one or more fully compliant specimen records (sequence record>500 bp with <1% n and with trace files available, voucher specimen with at least country of origin) have been assigned a green flag, while those only based on incomplete records are marked in yellow.

The full BIN database is available at http://www.boldsystems.orq/bin with an interface that supports four primary functions: search, browse, download, and annotate. Any BIN can be retrieved by its identifier or by features (geography, taxonomy, attribution metadata, literature references) associated with its members. Users can retrieve and download BIN data for any taxonomic group, or for a particular geographic region(s). When a search returns multiple BINs, users can browse the list, review summary information (taxonomy, geography, number of members) or obtain details on a particular BIN by selecting it.

BIN Data Model:

Each BIN owes its initial establishment to a single record, but this founder is often joined through time by other sequences which match it or which show low divergence from it. The addition of each new record may increase the clarity of the BIN boundaries in sequence space. BINs for common species eventually gain many records, while those for rare species may never be represented by more than one or two. As such, some BINs inevitably gain far richer metadata than others. BINs may be defined by their member records and the data model reflects this by aggregating information on taxonomic assignments, points of collection, images, sequences, and attribution details for all member specimens. Key data elements include the following:

1) Taxonomy: A summary of the formal and interim taxonomic assignments for all members of each BIN including higher taxonomic ranks. Each level in the taxonomic hierarchy associated with a BIN shows the number of the records attributed to a particular taxon. Cases of discordance are highlighted. Linkages between taxon names and the associated records are maintained so that taxonomic annotations made on a BIN can also be linked to individual records. It is important to emphasize that because BOLD is a workbench, the taxonomic summary may include both published and unpublished records. Users may encounter discordant taxonomic assignments, especially among unpublished records, but majority rule is a useful way to gauge the validity of a particular identification. For example, if most specimens are assigned to one species and these identifications derive from several taxonomists, this assignment is more likely to be correct than any ‘outlier’ identifications.

2) Distribution: All unique sampling coordinates may be gathered together with a count of the number of specimens at each site. Coordinates are linked to their original records to allow annotation.

3) Images: Images for all member records may be grouped by taxonomy and by orientation (e.g. ventral, dorsal).

4) Sequences: Sequences may be represented in three ways: 1) as a histogram of distances generated from all pairwise comparisons within the BIN together with a representative of the nearest neighbouring BIN, 2) as a neighbor-joining tree [54] and 3) as a haplotype similarity network diagram.

5) Micro-Attribution: Attribution details for each record may be provided with collector, identifier, photographer, sequencing facility, and specimen depository as primary fields. Attribution is tallied and sorted based on the number of records associated with each individual or institution.

Because key elements of specimen records on BOLD, especially taxonomic assignments, may be frequently revised by data providers and because of the high flow of new records, BIN metadata may be dynamic. MongoDB, a document database, was adopted because of its strong ability to deal with complex, evolving data structures where updates are frequent [55].

BIN Identifiers: Each BIN may be assigned two identifiers upon its establishment—a BOLD-generated URI and a Document Object Identifier (DOI). The URI is an internally managed alphanumeric identifier that is incremented with each new BIN. The BOLD acronym is used as a prefix for the URIs to ensure their discrimination from identifiers employed by other databases (e.g. BOLD:AAA0001 is the BIN for Homo sapiens). The DOI for each BIN is provided through the DataCite project (datacite.org), ensuring long-term persistence and resolution through the global registry hosted at dx.doi.org (e.g. DOI for H. sapiens is dx.doi.org/10.5883/BOLD:AAA0001). The assignment of a DOI may also enable each BIN to gain citation through standard practices [56]. Centralized resolution of identifiers may be particularly important in the case where two BINs are merged due to the submission of new sequence data which bridge a former gap or where a single BIN is split into two or more BINs when further sampling exposes a divide. In the event of a merger, following conventional taxonomic practice, the more recently registered BIN may be synonymized. In the case of a SPLIT, a new BIN may be established and a disambiguation option is presented. In both cases, the DOI may be amended to resolve lookups to the merged BIN or to the new BIN, ensuring that the original identifiers are never lost.

Community Annotation:

Each BIN page may incorporate collateral data and metadata provided by the record providers. As well, BIN metadata can gain third-party annotation through tags which employ controlled vocabularies, and free text commentary. Annotation may be dynamically linked to the primary data elements in the specimen records on BOLD, becoming a permanent part of each record. This may ensure that the annotation is visible whenever the impacted data elements are displayed, maximizing the value of each annotation. These tags can be viewed as community voting tools which enable expert groups to better evaluate the accuracy of taxonomic assignments and other metadata.

BIN Partitions:

As noted earlier, RESL merged 7.9% and split 2.7% of the species in the eight test datasets. These cases of discordance between BIN assignments and current taxonomy can have four explanations. They may reflect taxonomic error, sequence contamination, deficits in RESL, or the inability of sequence variation at COI to diagnose species because of introgression or their young age. Some discordances undoubtedly arise from taxonomic error with MERGES representing cases of overlooked synonymy, and SPLITS reflecting overlooked species. However, many MERGES may have another cause; RESL may fail to partition very young species because of their limited sequence divergence. Because many of these species do possess diagnostic nucleotide substitutions in the barcode region (e.g. [38]), the BIN system is being extended to incorporate expert decisions in such cases. Where two or more species with diagnostic substitutions have been merged in a BIN, an expert may divide this BIN by specifying the position of the diagnostic nucleotides that allow their discrimination. These new divisions are treated as partitions of the existing BIN by extending the URI with a decimal value. For example, BOLD:AAB2314.1 and BOLD:AAB2314.2 would indicate two species of tuna, Thunnus, that only differ by a single nucleotide substitution in the barcode region. The use of this decimalized BIN notation has the advantage of providing a clear signal that the results of the automated BIN workflow has gained further resolution through the intervention of an expert. Moreover, each of the decimalized URIs does receive a unique DOI to allow the retrieval of information on its members.

### 4. DISCUSSION

This paper describes the establishment of the Barcode Index Number (BIN) system as a persistent registry for animal OTUs recognized through sequence variation in the COI DNA barcode region. Its development had two primary motivations—to enable evaluations of biodiversity patterns in advance of fully developed taxonomy and to aid taxonomic progress. It builds on prior studies which have established that most animal species show less than 2% intraspecific variation at COI, but more than 4% divergence from their nearest neighbour [13, 57]. Several earlier studies have capitalized on this pattern of sequence variation to develop algorithms for the estimation of species numbers [25, 27, 28, 31]. While they may do a sufficient job, they may have been designed for a different purpose—to analyze sequences resulting from a single study. As such, their scalability may have not been tested, and none may have developed the informatics platform needed to store and compare the OTUs encountered in different studies. By contrast, this study has developed a persistent registry for OTUs, and an informatics platform enabling their storage and retrieval by expanding the capabilities of BOLD [42]. The two-algorithm process used by RESL to delineate OTUs (in one embodiment, single linkage cluster analysis followed by Markov clustering) performed strongly, delivering OTU counts with close concordance to actual species numbers in eight datasets. However, this congruence may have concealed a discrepancy—just 89% showed a perfect match to a recognized species. The much closer correspondence (99%) between the species and OTU counts was a product of the merger of some species in a single OTU and the partitioning of others. These results indicate that species counts can be estimated with high accuracy through RESL, but that OTUs and species may show lower overlap.

The taxonomic performance of RESL was stronger than that of ABGD, CROP, and jMOTU, but similar to that of GMYC. RESL delivered the highest incidence of MATCHES (89.2%) across the eight test datasets versus 85.2% for its closest competitor, CROP, and showed the least tendency to create SPLITS or MIXTURES. The performance of ABGD was very close to that of CROP and was slightly improved when the best partitioning scheme, of the multiple schemes output by the algorithm, was selected for each dataset, but it still delivered fewer MATCHES (86.8%) than RESL. GMYC, which could only be run on 7 of the 8 datasets, delivered a similar percentage of MATCHES as RESL, but required over 5000 times the computational effort to achieve this result. In fact, RESL generated OTU assignments 100 times more rapidly than the next fastest option. Its speed can be a major advantage, enabling the 1.8M COI sequences on BOLD to be reanalyzed every three days (on an IBM x3650 server with 24 CPU cores and 36 gigabytes of RAM), allowing rapid adjustments in the OTU array. Based on its speed and taxonomic performance, RESL was adopted as the algorithmic approach to underpin the Barcode Index Number System, a new module on BOLD which provides a persistent registry for the OTUs which, after gaining a DOI and URI, are termed a BIN.

The eight test datasets included three that targeted a regional fauna (Bavaria, Ireland, Argentina) and five that involved continental-scale analysis. The incidence of discordances was slightly higher in the latter studies, likely reflecting the impact of regional variation in barcode sequences. Cases of discordance between BINs and accepted species boundaries merit investigation to ascertain their source. Taxonomic errors may be responsible for some conflicts—cases of unrecognized synonymy may explain some MERGES, while overlooked species may create many SPLITS. Prior work has shown that the incidence of SPLITS rises with geographic scale. For example, in a study of 778 species of European geometrid moths, Hausmann [58] found that 7% of the taxa showed deep sequence divergence in local populations, but that the frequency of such cases rose to 17% when analysis spanned Europe. At least some, if not much, of this increase may involve reproductively isolated lineages that are not currently recognized as different species. Certainly, divergences at COI in excess of 2% are usually associated with reproductive incompatibility in freshwater fishes [59].

However, some SPLITS detected in our analyses likely reflect situations where intraspecific divergence is unusually high as a consequence of the inclusion of two or more phylogeographic lineages [60]. In these cases, sequence clusters assigned to different BINs may actually represent a single species. Such cases create no major difficulty—the BINs can share a species name and an annotation indicating that they represent a single species. While most SPLITS may involve overlooked species, many MERGES may arise from the difficulty in diagnosing closely allied species. Cases linked to mitochondrial introgression will never be resolved through mtDNA analysis [61], but might be partitioned through the analysis of one or more nuclear genes, suggesting that one future improvement for BIN delineation in these rare cases would involve the tactical incorporation of nuclear gene information. BOLD is prepared to support an identification service based on multiple markers as the current version (v3.0) can store data on up to 150 gene regions. Although additional sequencing may be required in cases of introgression, many MERGES may appear to have a simpler explanation—they involve young species that show so little sequence divergence that they cannot be separated algorithmically. However, many of these merged species do show diagnostic nucleotide substitutions in the barcode region that are correlated with the morphological or ecological traits used in species diagnosis [38]. This fact motivated the development of a decimalization option, which provides formal recognition for those BIN partitions that separate species that are too similar to gain algorithmic detection, but that possess diagnostic sequence characters in the barcode region.

TABLE 4
Taxonomic information associated with specimen records and
BINs on BOLD. Of the 2M sequence records on BOLD,
1.81M met the quality standards for a BIN assignment and they
include representatives of 274K BINs.

| | BINs (274K) | | SPECIMENS (1.81M) |
|---|---|---|---|
| | Taxonomic | Lacking Linnaean | Lacking Linnaean |
| Rank | Conflict | Name | Name |
| Phylum | 0.0% | 0.0% | 0.0% |
| Class | 0.0% | 0.1% | 0.3% |
| Order | 0.1% | 0.8% | 1.1% |
| Family | 1.6% | 10.1% | 11.7% |
| Genus | 4.1% | 23.7% | 19.0% |
| Species | 12.8% | 46.0% | 40.3% |

The BIN system does not stand in isolation. There is an ongoing drive to improve the Linnaean taxonomic assignment for all records on BOLD that lack species-level resolution. Table 4 reveals the extent of taxonomic uncertainty surrounding current BINs; 46% lack a species designation and 8% lack a family. This taxonomic uncertainty may need to be tackled strategically with initial efforts focused on securing a family assignment for every BIN. This work can be achieved with reasonable effort and the results can be immediately useful because many biological insights accompany this increased resolution. For example, an OTU assigned to the order Diptera brings little insight beyond the fact that its members are insects with two wings. By contrast, assignment to the family Culicidae indicates an aquatic larval lifestyle, adult females which bite, and a possible role in vectoring disease. Once every BIN has been assigned to a family, efforts can be directed towards gaining generic and finally species-level resolution. This work can create a positive feedback loop because BOLD gains increasing power to place new taxa within the Linnaean hierarchy as taxonomic parameterization rises. For example, because nearly 50% of the 150K described species of Lepidoptera now have a barcode record, BOLD may be able to correctly assign most newly encountered specimens in this order to a family. Despite uncertainty in taxonomic placement, the BIN system may enable examination of many issues that typically require species-level identifications. For example, it may provide a powerful tool to assess local biodiversity; one recent study exploited BINs to reveal unprecedented diversity in soil mites at an arctic site [62]. Aside from enabling estimates of alpha diversity, BIN analysis may permit examination of species turnover in space and time, enabling biotic change to be tracked with more precision than previously possible [63].

Aside from general algorithmic adjustments, RESL may be ‘tuned’ to maximize its performance for particular taxonomic groups or environments. For example, if patterns of sequence divergence differ in systematic ways among species in different taxonomic assemblages (phylum, class), in diverse habitats (e.g. marine, freshwater, terrestrial) or among those with differing capacities for dispersal (e.g. flight, no flight), the Markov clustering step in RESL can be adjusted through modification of the inflation parameter.

It should be noted that many BIN assignments may be stable despite algorithmic adjustments because the species that they represent are deeply divergent from allied taxa. Furthermore, when adjustments are made, it may be straightforward to incorporate an audit trail tracing the past history of each BIN.

By creating a structured registry for OTUs, the BIN system may provide the species-level information needed to empower biodiversity science. It may deliver a much-needed identification service for the animal kingdom, breaking barriers created by the lack of specialists available to carry out routine identifications. By assigning specimens to OTUs that closely approximate species and by aggregating collateral data, the BIN system may also illuminate dark taxa [19], revealing their distributions, morphologies and, as taxonomic parameterization advances, their coordinates in Linnaean space.

Various modifications and variations of the described methods and products of the invention will be apparent to those skilled in the art without departing from the scope of the invention. Although the invention has been described in connection with specific preferred embodiments, it should be understood that the invention as claimed should not be unduly limited to such specific embodiments. Indeed, various modifications of the described modes for carrying out the invention which are apparent to those skilled in the relevant fields are intended to be within the scope of the following claims.

### 5. REFERENCES

These are the references used in the description:
1. Trontelj P, Fi\check{s}er C (2009) Cryptic species should not be trivialized. Systematics and Biodiversity 7: 1-23.
2. Bickford D, Lohman D J, Sodhi N S, Ng P K, Meier R, et al. (2007) Cryptic species as a window on diversity and conservation. Trends in Ecology & Evolution 22: 148-155.
3. Carbayo F, Marque A C (2011) The cost of describing the entire animal kingdom. Trends in Ecology & Evolution 26: 154-155.
4. Mora C, Tittensor D P, Adl S, Simpson A G, Worm B (2011) How many species are there on earth and in the ocean? PLoS Biology 9: e1001127.
5. Stackebrandt E, Goebel B (1994) Taxonomic note: A place for DNA-DNA reassociation and 16S rDNA sequence analysis in the present species definition in bacteriology. International Journal of Systematic Bacteriology 44: 846-849.
6. Lozupone C A, Knight R (2009) Global patterns of bacterial diversity. Proc Natl Acad Sci USA 104: 11436-11440.
7. Buee M, Reich M, Murat C, Morin E, Nilsson R H, et al. (2009) 454 pyrosequencing analyses of forest soils reveal an unexpectedly high fungal diversity. New Phytologist 184: 449-456.
8. Kauserud H, Mathiesen C, Ohlson M (2008) High diversity of fungi associated with living parts of boreal forest bryophytes. Botany 86: 1326-1333.
9. Blaxter M, Elsworth B, Daub J (2004) DNA taxonomy of a neglected animal phylum: an unexpected diversity of tardigrades. Proceedings of the Royal Society B: Biological Sciences 271: S189-S192.
10. Robeson M S, King A J, Freeman K R, Birky Jr C W, Martin A P, et al (2011) Soil rotifer communities are extremely diverse globally but spatially autocorrelated locally. Proc Natl Acad Sci USA 108: 4406-4410.
11. Hill R S (1980) A stopping rule for partitioning dendrograms. Botanical Gazette 141: 321-324.
12. Hebert P D N, Cywinska A, Ball S L, deWaard J R (2003a) Biological identifications through DNA barcodes. Proceedings of the Royal Society B: Biological Sciences 270: 313-321.
13. Hebert P D N, Ratnasingham S, deWaard J R (2003b) Barcoding animal life: cytochrome c oxidase subunit 1 divergences among closely related species. Proceedings of the Royal Society B: Biological Sciences 270: 596-599.
14. Meyer C P, Paulay G (2005) DNA barcoding: error rates based on comprehensive sampling. PLoS Biology 3: e422. doi:10.1371/journal.pbio.0030422.
15. Ward R D, Zemlak T S, Innes B H, Last P R, Hebert P D N (2005) DNA barcoding Australia's fish species. Philosophical Transactions of the Royal Society B: Biological Sciences 360: 1847-1857.
16. Hajibabaei M, Janzen D H, Burns M J, Hallwachs W, Hebert P D N (2006) DNA barcodes distinguish species of tropical Lepidoptera. Proc Natl Acad Sci USA 103: 968-971.
17. Waugh J (2007) DNA barcoding in animal species: progress, potential and pitfalls. BioEssays 29: 188-197.
18. Bucklin A, Steinke D, Blanco-Bercial L (2011) DNA barcoding of marine Metazoa. Annual Review of Marine Sciences 3: 471-508.
19. Page R D M (2011) Dark taxa: GenBank in a post-taxonomic world. iPhylo blog, http://iphylo.blogspot.ca/2011/04/dark-taxa-genbank-in-post-taxonomic.html.
20. Schloss P D, Handelsman J (2005) Introducing DOTUR, a computer program for defining operational taxonomic units and estimating species richness. Applied Environmental Microbiology 71: 1501-1506.
21. Li W, Godzik A (2006) Cd-hit: a fast program for clustering and comparing large sets of protein or nucleotide sequences. Bioinformatics 22: 1658-1659.
22. Schloss P D, Westcott S L, Ryabin T, Hall J R, Hartmann M, et al. (2009) Introducing mothur: open-source, platform-independent, community-supported software for describing and comparing microbial communities. Applied Environmental Microbiology 75: 7537-7541.
23. Kumar S, Carlsen T, Mevik B-H, Enger P, Blaalid R, et al. (2011) CLOTU: an online pipeline for processing and clustering of 454 amplicon reads into OTUs followed by taxonomic annotation. BMC Bioinformatics 12: 182.
24. Blaxter M, Mann J, Chapman T, Thomas F, Whitton C, et al. (2005) Defining operational taxonomic units using DNA barcode data. Philosophical Transactions of the Royal Society B: Biological Sciences 360: 1935-1943.
25. Jones M, Ghoorah A, Blaxter M (2011) jMOTU and Taxonerator: Turning DNA barcode sequences into annotated operational taxonomic units. PLoS ONE 6: e19259.
26. Murtagh F (1983) A survey of recent advances in hierarchical clustering algorithms. Computer Journal 26: 354-359.
27. Puillandre N, Lambert A, Brouillet S, Achaz G (2012) ABGD, Automatic Barcode Gap Discovery for primary species delimitation. Molecular Ecology 21: 1864-1877.
28. Hao X, Jiang R, Chen T (2011) Clustering 16S rRNA for OTU prediction: a method of unsupervised Bayesian clustering. Bioinformatics 27: 611-618.
29. Needleman S B, Wunsch C D (1970) A general method applicable to the search for similarities in the amino acid sequence of two proteins. Journal of Molecular Biology 48: 443-453.
30. Sogin M L, Morrison H G, Huber J A, Welch D M, Huse S M, et al. (2006) Microbial diversity in the deep sea and the underexplored “rare biosphere”. Proc Natl Acad Sci USA 103: 12115-12120.
31. Pons J, Barraclough T, Gomez-Zurita J, Cardoso A, Duran D, et al. (2006) Sequence-based species delimitation for the DNA taxonomy of undescribed insects. Systematic Biology 55: 595-609.
32. Monaghan M T, Wild R, Elliot M, Fujisawa T, Balke M, et al. (2009): Accelerated species inventory on Madagascar using coalescent-based models of species delineation. Systematic Biology 58: 298-311.
33. Papadopoulou A, Anastasiou I, Spagopoulou F, Stalimerou M, Terzopoulou S, et al. (2011) Testing the species-genetic diversity correlation in the Aegean archipelago: toward a haplotype-based macroecology? American Naturalist 178: 241-255.
34. Pons J, Fujisawa T, Claridge E M, Savill R A, Barraclough T G, et al (2011) Deep mtDNA subdivision within Linnaean species in an endemic radiation of tiger beetles from New Zealand (Genus Neocicindela). Molecular Phylogenetics and Evolution 59: 251-262.
35. Lovász L (1993) Random walks on graphs: A survey. pp. 1-46 in Combinatorics, Paul Erdös is Eighty (Volume 2), Keszthely (Hungary).
36. Van Dongen S (2008) Graph clustering via a discrete uncoupling process. SIAM Journal on Matrix Analysis and Applications 30: 121-141.
37. Rousseeuw P J (1987) Silhouettes: A graphical aid to the interpretation and validation of cluster analysis. Journal of Computational and Applied Mathematics 20: 53-65. doi:10.1016/0377-0427(87)90125-7.
38. Burns J M, Janzen D J, Hajibabaei M, Hallwachs W, Hebert P D N (2007) DNA barcodes of closely related (but morphologically and ecologically distinct) species of skipper butterflies (Hesperiidae) can differ by only one to three nucleotides. Journal of the Lepidopterists Society 61: 138-153.
39. Larsen B, Aone C (1999) Fast and effective text mining using linear-time document clustering. In: Proc. 5th ACMSIGKDD Intl. Conf. on Knowledge Discovery and Data Mining (pp. 16-22).
40. Berners-Lee T, Fielding R T, Masinter L (2005) Uniform Resource Identifier (URI): generic syntax. IETF RFP3986 (standards track), Internet Eng. Task Force. www.ietf.org/rfc/rfc3986.txt.
41. Schindel D E, Miller S E (2010) Provisional nomenclature: The on-ramp to taxonomic names. Pp 109-115. In Systema Naturae 250: The Linnaean Ark. Ed A Polaszek. Boca Raton, Fla.
42. Ratnasingham S, Hebert P D N (2007) BOLD: the Barcode of Life Data System (www.barcodinglife.org). Molecular Ecology Notes 7: 355-364.
43. Eddy S R (1998) Profile hidden Markov models. Bioinformatics 14: 755-763.
44. Finn R D, Mistry J, Tate J, Coggill P, Heger A, et al. (2010) The Pfam protein families database. Nucleic Acids Research 38: D211-D222.
45. Johnson S C (1967) Hierarchical clustering schemes. Psychometrika 32: 241-254.
46. Augustson J G, Minker J (1970) An analysis of some graph theoretical cluster techniques. Journal for the Association of Computing Machinery 17: 571-588.
47. Prim R C (1957): Shortest connection networks and some generalizations. In: Bell System Technical Journal, 36: 1389-1401.
48. Huber T, Faulkner G, Hugenholtz P (2004) Bellerophon: a program to detect chimeric sequences in multiple sequence alignments. Bioinformatics 20: 2317-2319.
49. Katoh K, Misawa K, Kuma K I, Miyata T (2002) MAFFT: a novel method for rapid multiple sequence alignment based on fast Fourier transform. Nucleic Acids Research 30: 3059-3066.
50. Drummond A J, Suchard M A, Xie D, Rambaut A (2012) Bayesian phylogenetics with BEAUti and the BEAST 1.7. Molecular Biology and Evolution 29: 1969-1973. doi:10.1093/molbev/mss075.
51. Darriba D, Taboada G L, Doallo R, Posada D (2012) jModelTest 2: more models, new heuristics and parallel computing. Nature Methods 9: 772. doi:10.1038/nmeth.2109.
52. Paradis E, Claude J, Strimmer K (2004) APE: analyses of phylogenetics and evolution in R language. Bioinformatics 20: 289-290.
53. Hausmann A, Haszprunar G, Hebert P D N (2011) DNA barcoding the geometrid fauna of Bavaria (Lepidoptera): Successes, surprises and questions. PLoS ONE 6: e17134.
54. Saitou N, Nei M (1987) The neighbor-joining method: a new method for reconstructing phylogenetic trees. Molecular Biology and Evolution 4: 406-425.
55. Tauro C J M, Aravindh S, Shreeharsha A B (2012) Comparative study of the new generation, agile, scalable, high performance NOSQL databases. International Journal of Computer Applications 48: 1-4.
56. Paskin N (2005) Digital Object Identifiers for scientific data. Data Science Journal 4: 12-20.
57. Mutanen M, Hausmann A, Hebert P D N, Landry J-F, deWaard J R, et al (2012) Allopatry as a Gordian knot for taxonomists: Patterns of DNA barcode divergence in arctic-alpine Lepidoptera. PLoS ONE 7:e47214.
58. Hausmann A (2011) An integrative taxonomic approach to resolving some difficult questions in the Larentiinae of the Mediterranean region. Mitteilungen Münchner Entomologische Gesellschaft 101: 73-97.
59. April J, Hanner R H, Dion-Cote A-M, Bernatchez L (2012) Glacial cycles as an allopatric speciation pump in north-eastern American freshwater fishes. Molecular Ecology: doi: 10.1111/mec.12116.
60. Avise J C (2000) Phylogeography, the History and Formation of Species. Harvard University Press, Cambridge, Mass.
61. Harrison R G (1993) Hybrid Zones and the Evolutionary Process. Oxford University Press. New York.
62. Young M R, Behan-Pelletier V M, Hebert P D N (2012) Revealing the hyperdiverse mite fauna of subarctic Canada through DNA barcoding. PLoS ONE 7: e48755.
63. Carr C M, Hardy S M, Brown T, Sheldon T, Macdonald T, et al (2011) A tri-oceanic perspective: DNA barcoding reveals geographic structure and cryptic diversity in Canadian polychaetes. PLoS ONE 6: e22232.
64. Kerr K C R, Lijtmaer D A, Barreira A S, Hebert P D N, Tubaro P L (2009) Probing evolutionary patterns in Neotropical birds through DNA barcodes. PLoS ONE 4: e4379.
65. Kerr K C R, Stoeckle M Y, Dove C J, Weigt L A, Francis C M, et at (2007) Comprehensive DNA barcode coverage of North American birds. Molecular Ecology Notes 7: 535-543.
66. Magnacca K N, Brown M J (2012) Barcoding a regional fauna: Irish solitary bees. Molecular Ecology Research 12: 990-998.
67. Hubert N, Hanner R, Holm E, Mandrak N E, Taylor E, et al. (2008) Identifying Canadian freshwater fishes through DNA barcodes. PLoS ONE 3: e2490
68. Hebert P D N, deWaard J R, Landry J F (2009) DNA barcodes for 1/1000 of the animal kingdom. Biology Letters 6: 359-362.

1. A method for operating a computer system to filter out clusters from a group of clusters from further consideration during a process of merging a new nucleic acid or amino acid sequence into the group of clusters based on sequence similarity, the computer comprising a processor and a memory, the method comprising:
a) determining a candidate cluster set including a plurality of candidate clusters, each candidate cluster comprising a plurality of previously classified nucleic acid or amino acid sequences wherein each previously classified nucleic acid or amino acid sequence in a cluster is closer to at least one other previously classified nucleic acid or amino acid sequence in that cluster than to any previously classified nucleic acid or amino acid sequences in other clusters;
b) using the processor of the computer system to determine a plurality of sets of representative sequences, by determining, for each of the candidate clusters in the candidate cluster set, a set of one or more representative sequences, wherein for at least one candidate cluster, the number of representative sequences in the set of one or more representative sequences of the candidate cluster is less than the number of previously classified nucleic acid or amino acid sequences in the plurality of previously classified nucleic acid or amino acid sequences of the candidate cluster;
c) using the processor to determine a plurality of candidate cluster distance measures, by determining, for each of the candidate clusters in the candidate cluster set, a candidate cluster distance measure between the new nucleic acid or amino acid sequence and the candidate cluster, wherein the candidate cluster distance measure between the new nucleic acid or amino acid sequence and the candidate cluster is determined by determining the distance between the nucleic acid or amino acid sequence and the set of one or more representative sequences of the candidate cluster; and
d) using the processor to filter out from further consideration each candidate cluster in the candidate cluster set if and only if the associated candidate cluster distance measure of the candidate cluster is greater than a pre-defined filtering threshold, and retaining and storing in the memory all other candidate clusters in the candidate cluster set for further consideration.

2. The method as defined in claim 1 wherein
the candidate cluster set comprises a candidate cluster subset of small diameter, and
each candidate cluster in the candidate cluster subset of small diameter has a maximum intra-cluster distance that is less than a pre-defined maximum intra-cluster distance threshold, the maximum intra-cluster distance of each candidate cluster being a measure of the distance between the two previously classified nucleic acid or amino acid sequences that are the furthest from each other in the plurality of previously classified nucleic acid or amino acid sequences of the candidate cluster.

3. The method as defined in claim 2 wherein for each candidate cluster in the candidate cluster subset of small diameter, d) comprises setting the pre-defined filtering threshold to be at least twice the maximum intra-cluster distance threshold.

4. The method as defined in claim 2 wherein for each candidate cluster in the candidate cluster subset of small diameter, the set of one or more representative sequences for that candidate cluster comprises only a single representative sequence.

5. The method as defined in claim 1 further comprising, after using the processor to filter out from further consideration each candidate cluster in the candidate cluster set if and only if the associated candidate cluster distance measure of the candidate cluster is greater than the pre-defined filtering threshold, and retaining all the other candidate clusters in the candidate cluster set for further consideration, for each candidate cluster in all the other candidate clusters in the candidate cluster set, operating the processor to apply haplotype compression to each sequence in that candidate cluster.

6. A data processing system for filtering out clusters from a group of clusters from further consideration during a process of merging a new nucleic acid or amino acid sequence into the group of clusters based on sequence similarity, the data processing system comprising a processor, a memory, and instructions recorded in the memory for configuring the processor to
a) determine a candidate cluster set including a plurality of candidate clusters, each candidate cluster comprising a plurality of previously classified nucleic acid or amino acid sequences wherein each previously classified nucleic acid or amino acid sequence in a cluster is closer to at least one other previously classified nucleic acid or amino acid sequence in that cluster than to any previously classified nucleic acid or amino acid sequences in other clusters;
b) determine a plurality of sets of representative sequences, by determining, for each of the candidate clusters in the candidate cluster set, a set of one or more representative sequences, wherein for at least one candidate cluster, the number of representative sequences in the set of one or more representative sequences of the candidate cluster is less than the number of previously classified nucleic acid or amino acid sequences in the plurality of previously classified nucleic acid or amino acid sequences of the candidate cluster;
c) determine a plurality of candidate cluster distance measures, by determining, for each of the candidate clusters in the candidate cluster set, a candidate cluster distance measure between the new nucleic acid or amino acid sequence and the candidate cluster, wherein the candidate cluster distance measure between the new nucleic acid or amino acid sequence and the candidate cluster is determined by determining the distance between the nucleic acid or amino acid sequence and the set of one or more representative sequences of the candidate cluster; and
d) filter out from further consideration each candidate cluster in the candidate cluster set if and only if the associated candidate cluster distance measure of the candidate cluster is greater than a pre-defined filtering threshold, and retaining and storing in the memory all other candidate clusters in the candidate cluster set for further consideration.

7. (canceled)

8. A computer program product for use on a computer system to filter out clusters from a group of clusters from further consideration during a process of merging a new nucleic acid or amino acid sequence into the group of clusters based on sequence similarity, the computer program product comprising a non-transitory computer readable recording medium, and instructions recorded on the recording medium for instructing the computer system to
a) determine a candidate cluster set including a plurality of candidate clusters, each candidate cluster comprising a plurality of previously classified nucleic acid or amino acid sequences wherein each previously classified nucleic acid or amino acid sequence in a cluster is closer to at least one other previously classified nucleic acid or amino acid sequence in that cluster than to any previously classified nucleic acid or amino acid sequences in other clusters;
b) determine a plurality of sets of representative sequences, by determining, for each of the candidate clusters in the candidate cluster set, a set of one or more representative sequences, wherein for at least one candidate cluster, the number of representative sequences in the set of one or more representative sequences of the candidate cluster is less than the number of previously classified nucleic acid or amino acid sequences in the plurality of previously classified nucleic acid or amino acid sequences of the candidate cluster;
c) determine a plurality of candidate cluster distance measures, by determining, for each of the candidate clusters in the candidate cluster set, a candidate cluster distance measure between the new nucleic acid or amino acid sequence and the candidate cluster, wherein the candidate cluster distance measure between the new nucleic acid or amino acid sequence and the candidate cluster is determined by determining the distance between the nucleic acid or amino acid sequence and the set of one or more representative sequences of the candidate cluster; and
d) filter out from further consideration each candidate cluster in the candidate cluster set if and only if the associated candidate cluster distance measure of the candidate cluster is greater than a pre-defined filtering threshold, and retaining and storing in the memory all other candidate clusters in the candidate cluster set for further consideration.

9. (canceled)

10. A method for operating a computer system to derive data from a plurality of nucleic acid sequences, the computer comprising a processor and a memory, the method comprising:
providing a plurality of computer-readable sequence representations comprising, for each nucleic acid sequence in the plurality of nucleic acid sequences, a corresponding computer-readable sequence representation having an ordered sequence of residue representations comprising, for each residue in that nucleic acid sequence, a corresponding residue representation, wherein each nucleic acid sequence in the plurality of nucleic acid sequences comprises at least X residues, X being an integer greater than 300;
providing a scanning window for collecting sequence-specific data for each sequence representation in the plurality of computer-readable sequence representations by sliding along each sequence in the plurality of computer-readable sequence representations, the scanning window having a pre-defined length W defining a number of residue representations in a portion of the sequence representation that are concurrently scannable by the computer by positioning the scanning window over that portion of the sequence representation, W being an integer greater than 10 and less than X;
operating the processor to position the scanning window at a first portion of the sequence representation, scan the first portion of the sequence representation to obtain first portion scan results; and then
operating the processor to reposition the scanning window at a second portion of the sequence representation, scan the second portion of the sequence representation to obtain second portion scan results, the second portion being different from the first portion.

11. The method as defined in claim 10 further comprising, after operating the processor to record in the index in the memory the second portion scan results, successively operating the processor to reposition the scanning window at different portions of the sequence representation, scan the different portions of the sequence representation to obtain scan results for each portion in the different portions.

12. The method as defined in claim 10 wherein the scan results for each portion comprises a percentage of at least one nucleic acid residue represented by the residue representations in that portion of the sequence representation, and the method further comprises storing the scan results for at least one portion in an index in the memory.

13. The method as defined in claim 10 wherein the scan results for each portion comprises a percentage of nucleic acid residues that are G or C (% GC) represented by the residue representations in that portion of the sequence representation.

14. The method as defined in claim 13 wherein storing the scan results for at least one portion in an index in the memory comprises storing the scan portion results for a lower bound portion having a lowest % GC, and the scan portion results for an upper bound portion having a highest % GC.

15. The method as defined in claim 12 further comprising merging a new nucleic acid sequence into a candidate cluster comprising at least one previously classified nucleic acid sequence, by
based on the scan portion results selected from the first portion scan results, the second portion scan results and the scan results for each portion in the different portions, for each nucleic acid sequence in the plurality of nucleic acid sequences, filtering out dissimilar nucleic acid sequences in the plurality of nucleic acid sequences wherein the dissimilar nucleic acid sequences have associated portion scan results stored in the index differing by more than a scan result threshold stored in memory from the portion scan result stored in the index for the new nucleic acid sequence;
determining a candidate cluster set including a plurality of candidate clusters, each candidate cluster comprising a plurality of previously classified nucleic acid sequences wherein each previously classified nucleic acid sequence in a cluster is closer to at least one other previously classified nucleic acid sequence in that cluster than to any previously classified nucleic acid sequences in other clusters;
using the processor of the computer system to determine a plurality of sets of representative sequences, by determining, for each of the candidate clusters in the candidate cluster set, a set of one or more representative sequences, wherein for at least one candidate cluster, the number of representative sequences in the set of one or more representative sequences of the candidate cluster is less than the number of previously classified nucleic acid sequences in the plurality of previously classified nucleic acid sequences of the candidate cluster;
using the processor to determine a plurality of candidate cluster distance measures, by determining, for each of the candidate clusters in the candidate cluster set, a candidate cluster distance measure between the new nucleic acid sequence and the candidate cluster, wherein the candidate cluster distance measure between the new nucleic acid sequence and the candidate cluster is determined by determining the distance between the nucleic acid sequence and the set of one or more representative sequences of the candidate cluster; and
using the processor to filter out from further consideration each candidate cluster in the candidate cluster set if and only if the associated candidate cluster distance measure of the candidate cluster is greater than a pre-defined filtering threshold, and retaining and storing in the memory all other candidate clusters in the candidate cluster set for further consideration.

16. A data processing system for deriving data from a plurality of nucleic acid sequences, the data processing system comprising a processor, a memory, and instructions recorded in the memory for configuring the processor to
provide a plurality of computer-readable sequence representations comprising, for each nucleic acid sequence in the plurality of nucleic acid sequences, a corresponding computer-readable sequence representation having an ordered sequence of residue representations comprising, for each residue in that nucleic acid sequence, a corresponding residue representation, wherein each nucleic acid sequence in the plurality of nucleic acid sequences comprises at least X residues, X being an integer greater than 300;
provide a scanning window for collecting sequence-specific data for each sequence representation in the plurality of computer-readable sequence representations by sliding along each sequence in the plurality of computer-readable sequence representations, the scanning window having a pre-defined length W defining a number of residue representations in a portion of the sequence representation that are concurrently scannable by the computer by positioning the scanning window over that portion of the sequence.

17. (canceled)

18. A computer program product for use on a computer system to derive data from a plurality of nucleic acid sequences, the computer program product comprising a non-transitory computer readable recording medium, and instructions recorded on the recording medium for instructing the computer system to
provide a plurality of computer-readable sequence representations comprising, for each nucleic acid sequence in the plurality of nucleic acid sequences, a corresponding computer-readable sequence representation having an ordered sequence of residue representations comprising, for each residue in that nucleic acid sequence, a corresponding residue representation, wherein each nucleic acid sequence in the plurality of nucleic acid sequences comprises at least X residues, X being an integer greater than 300; and
provide a scanning window for collecting sequence-specific data for each sequence representation in the plurality of computer-readable sequence representations by sliding along each sequence in the plurality of computer-readable sequence representations, the scanning window having a pre-defined length W defining a number of residue representations in a portion of the sequence representation that are concurrently scannable by the computer by positioning the scanning window over that portion of the sequence.

19. (canceled)
